(19) United States
(12) Patent Application Publication
(10) Pub. No.: US 2012/0168537 A1
(43) Pub. Date: Jul. 5, 2012

(54) REACTOR FEED NOZZLES

(75) Inventors: Stephen K. Pavel, Kingwood, TX (US); Michael A. Silverman, Houston, TX (US); Steven A. Kalota, Irvine, CA (US)

(73) Assignee: Ivanhoe Energy, Inc.

(21) Appl. No.: 13/340,487

(22) Filed: Dec. 29, 2011

Related U.S. Application Data
(60) Provisional application No. 61/428,104, filed on Dec. 29, 2010.

(51) Int. Cl. A62C 31/02

(52) U.S. Cl. 239/589

(57) ABSTRACT

Improved reactor feed nozzles are disclosed. According to one embodiment, a feed nozzle comprises an inner tubing encased within an outer heat shield tubing, a first circular hole fabricated in the inner tubing, the first circular hole having a first diameter and serving as a discharge hole, a second circular hole fabricated in the outer heat shield tubing, the second circular hole having a second diameter, wherein the second diameter is larger than the first diameter; and a welded tip for extending a flow path at a declining angle, the welded tip having a section extending at a predetermined angle from the inner tubing to the discharge hole.

The present application claims the benefit of and priority to U.S. Provisional Application Ser. No. 61/428,104, titled “FEED NOZZLES FOR USE IN THERMAL PROCESSING OF HEAVY HYDROCARBONS FEEDSTOCKS,” filed on Dec. 29, 2011, which is hereby incorporated by reference herein in its entirety for all purposes.

### FIELD

The present invention generally relates to rapid thermal processing of viscous oil feedstock. More specifically, the present invention is directed to injection nozzles for supplying feedstock into short residence-time pyrolytic reactors.

### BACKGROUND

Heavy oil and bitumen resources are supplementing the decline in the production of conventional light and medium crude oils, and production from these resources is steadily increasing. Pipelines cannot transport the crude oils unless diluents are added to decrease their viscosity and specific gravity to pipeline specifications. Alternatively, desirable properties are achieved by primary upgrading. However, diluted crudes or upgraded synthetic crudes are significantly different from conventional crude oils. As a result, bitumen blends or synthetic crudes are not easily processed in conventional fluid catalytic cracking refineries. Therefore, in either case further processing must be done in refineries configured to handle either diluted or upgraded feedstocks.

The use of fluid catalytic cracking (FCC) or other units for the direct processing of bitumen feedstocks is known in the art. However, many compounds present within the crude feedstocks interfere with these processes by depositing on the contact material itself. These feedstock contaminants include metals such as vanadium and nickel, coke precursors such as (Conradson) carbon residues, and asphaltenes. Unless carbonaceous materials are removed by combustion in a regenerator, deposits of these materials can result in poisoning and the need for premature replacement of the contact material. This is especially true for contact material employed with FCC processes, as efficient cracking and proper temperature control of the process requires contact materials comprising little or no combustible deposit materials or metals that interfere with the catalytic process.

In the injection nozzles for feedstock, coke may be formed in the flowline. This may eventually result in a diminished passage for liquid and dispersion gas that can include, but is not limited to steam, product gas, flue gas, nitrogen, carbon dioxide, in the mixing nozzle, resulting in an increase of the pressure drop over the mixing nozzle.

Further, it is common to pre-heat an oil feedstock in order to enhance vaporization and cracking of the oil in a separation unit. When the feedstock is so heated, some of the oil is vaporized prior to its introduction to a nozzle for dispersion. Thus, the feedstock stream may comprise a two phase flow consisting of steam and oil vapor, on one hand, and liquid oil when it is injected into the nozzle for dispersion. Dispersion of two phase fluids increases nozzle wear. Also, nozzle dispersion of a two phase fluid results in less efficient dispersion than when a single liquid phase is introduced to the nozzle. Further, slugs of liquid and gas emitted from the nozzle can momentarily disrupt the solid heat carrier-oil ratio in the unit, changing product distribution. It would be clearly desirable to provide an apparatus and process in which the liquid phase of a two phase hydrocarbon feedstock stream may be fully dispersed when it is introduced to the reactor to contact the solid heat carrier.

### SUMMARY

Improved reactor feed nozzles are disclosed. According to one embodiment, a feed nozzle comprises an inner tubing encased within an outer heat shield tubing, a first circular hole fabricated in the inner tubing, the first circular hole having a first diameter and serving as a discharge hole, a second circular hole fabricated in the outer heat shield tubing, the second circular hole having a second diameter, wherein the second diameter is larger than the first diameter; and a welded tip for extending a flow path at a declining angle, the welded tip having a section extending at a predetermined angle from the inner tubing to the discharge hole.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

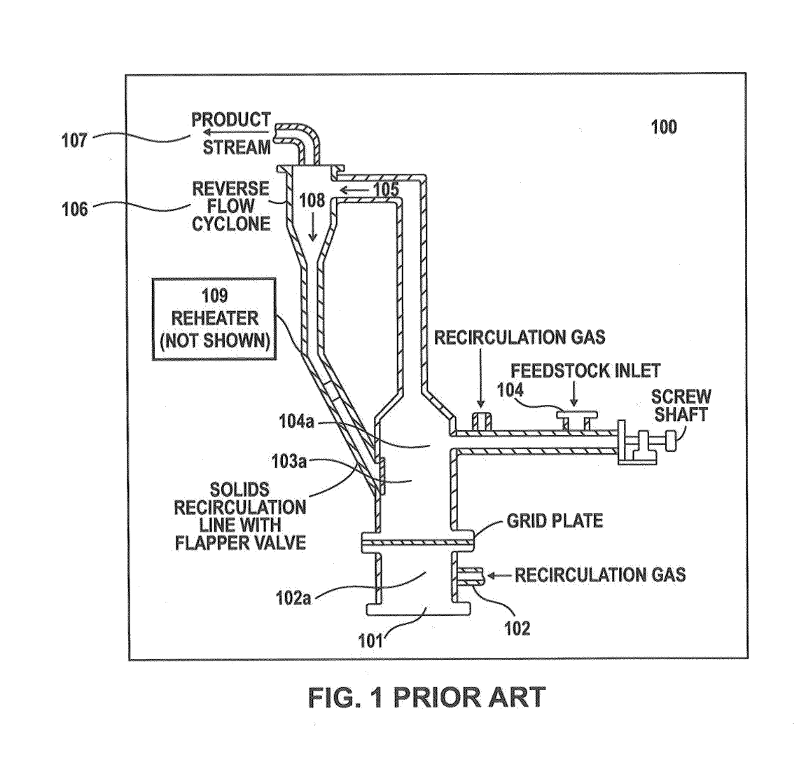

FIG. 1 illustrates a prior art reactor design.

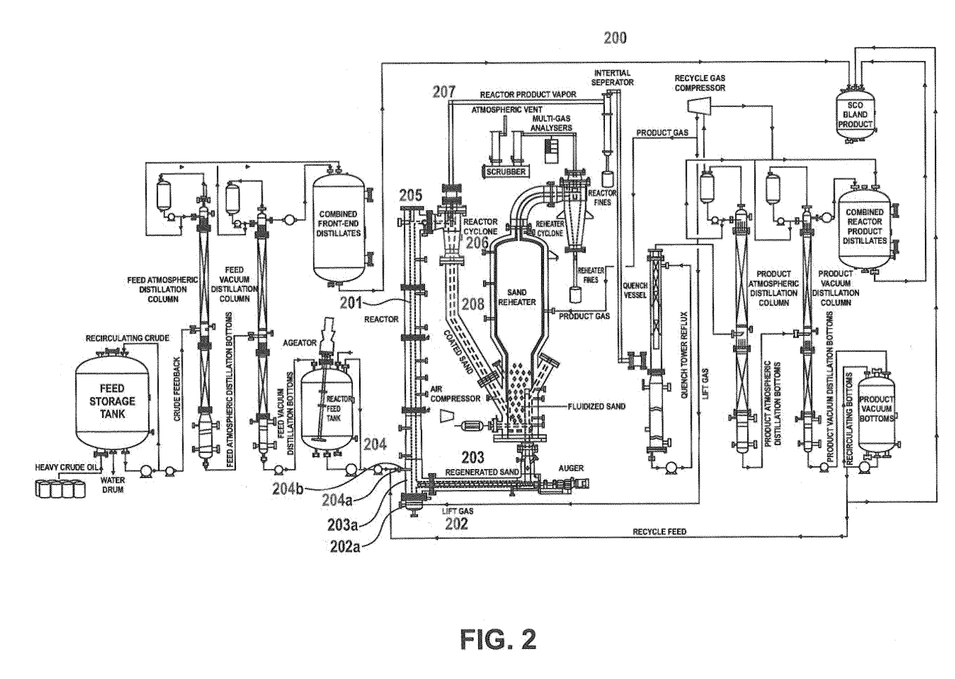

FIG. 2 illustrates an exemplary reactor design for use with the present system, according to one embodiment.

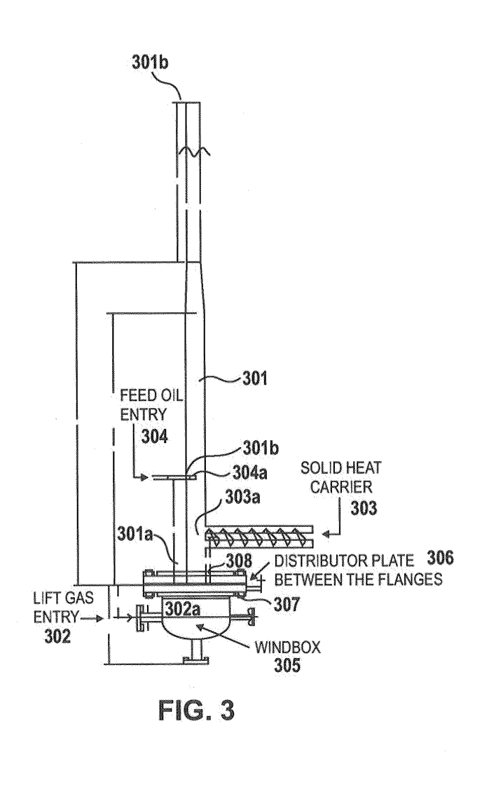

FIG. 3 illustrates an exemplary reactor configuration for use with the present system, according to one embodiment.

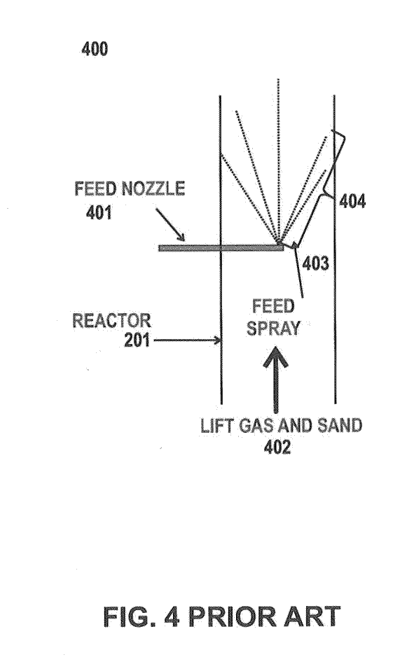

FIG. 4 illustrates a prior art feed nozzle.

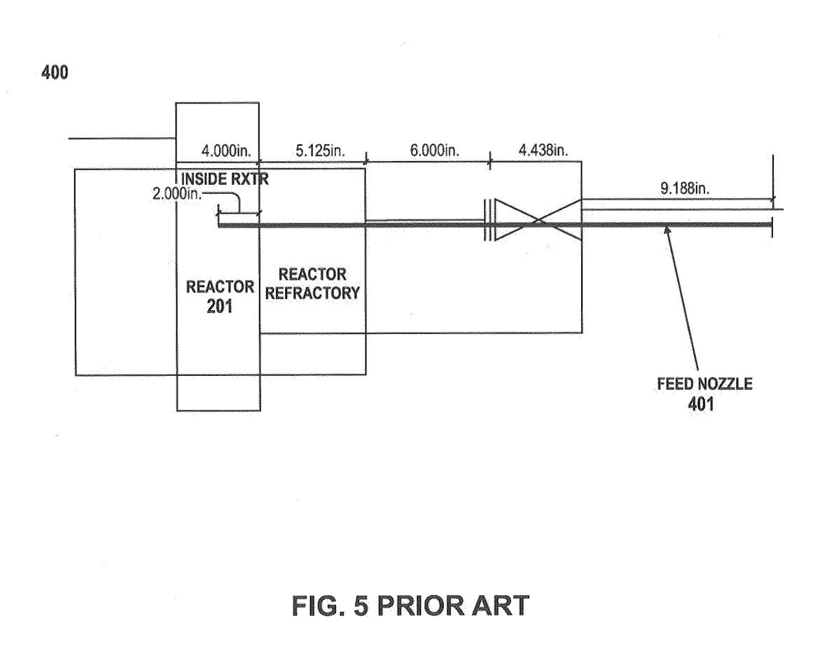

FIG. 5 illustrates a detail view of a prior art feed nozzle configuration within a reactor.

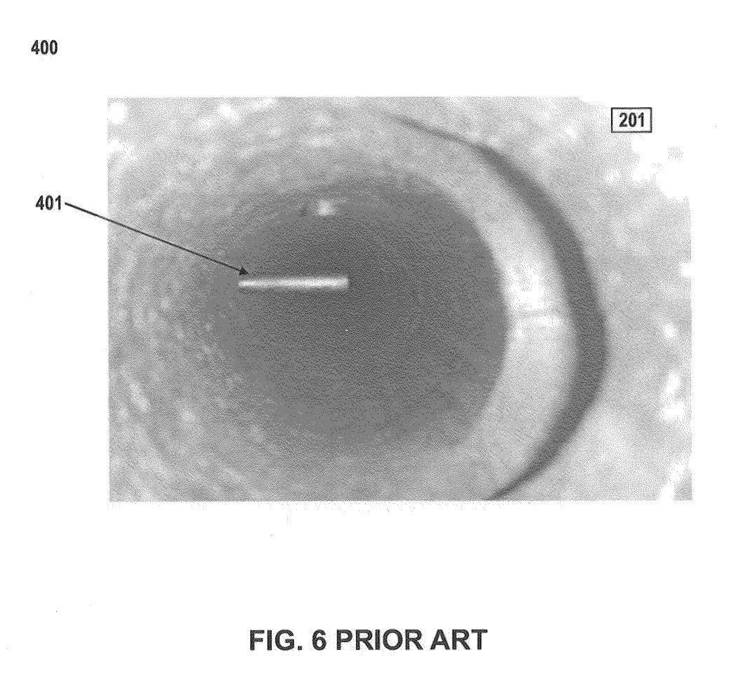

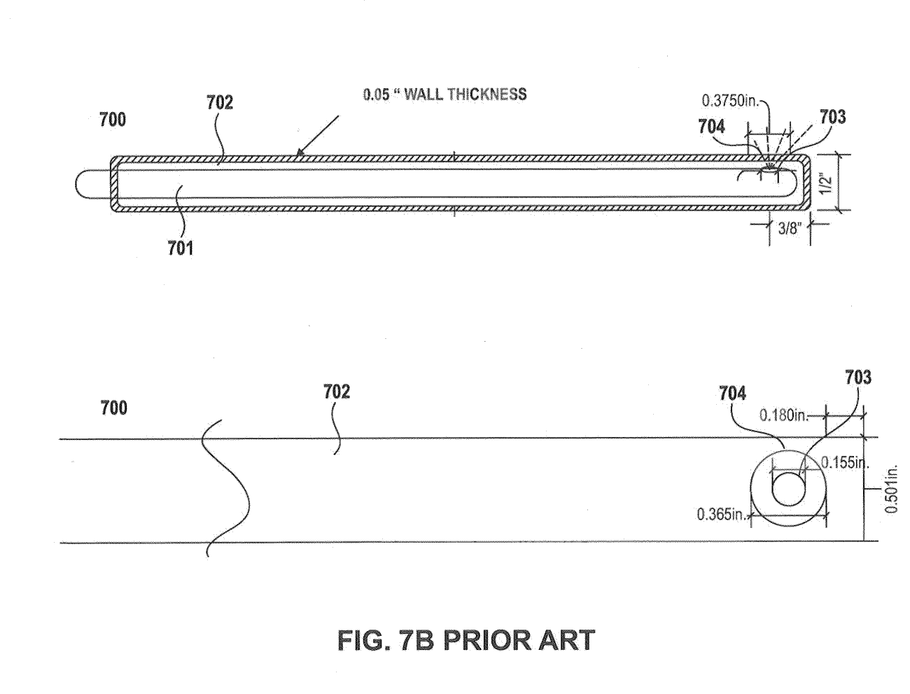

FIG. 6 illustrates a bottom view of a prior art feed nozzle configuration within a reactor.

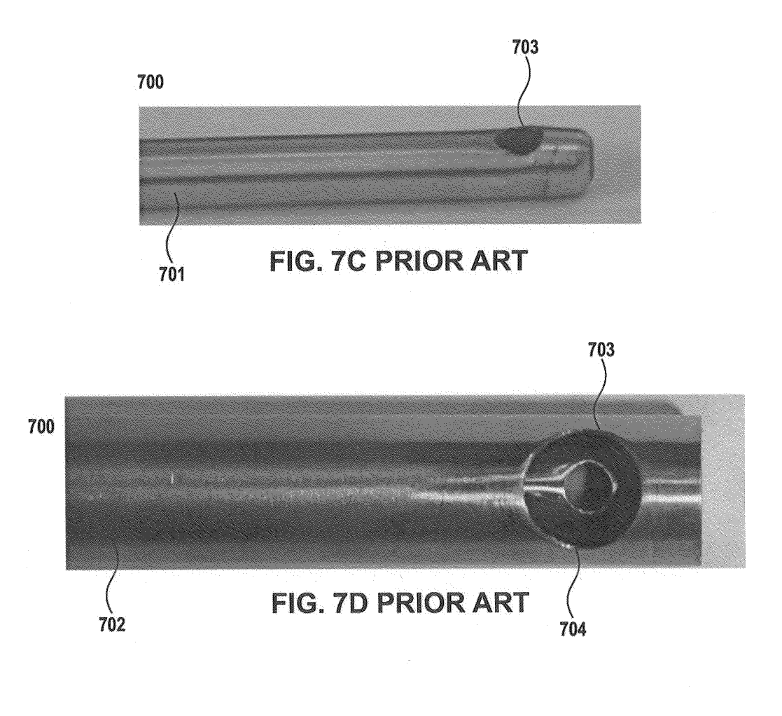

FIG. 7A illustrates a side view of a prior art feed nozzle.

FIG. 7B illustrates a front or top view of a prior art feed nozzle.

FIG. 7C illustrates a prior art feed nozzle inner tubing without a heat shield.

FIG. 7D illustrates a prior art feed nozzle heat shield.

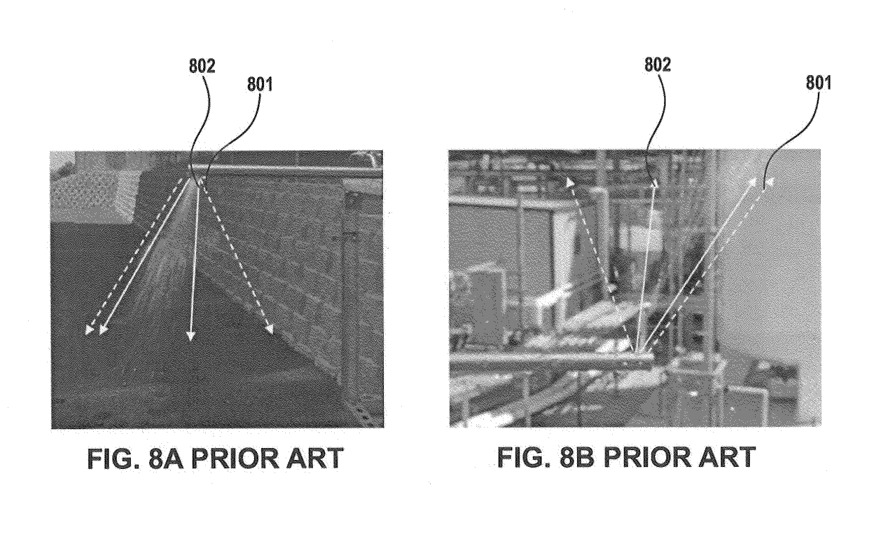

FIGS. 8A and 8B illustrate a spray pattern produced by a prior art feed nozzle design depicted in FIGS. 7A-7D.

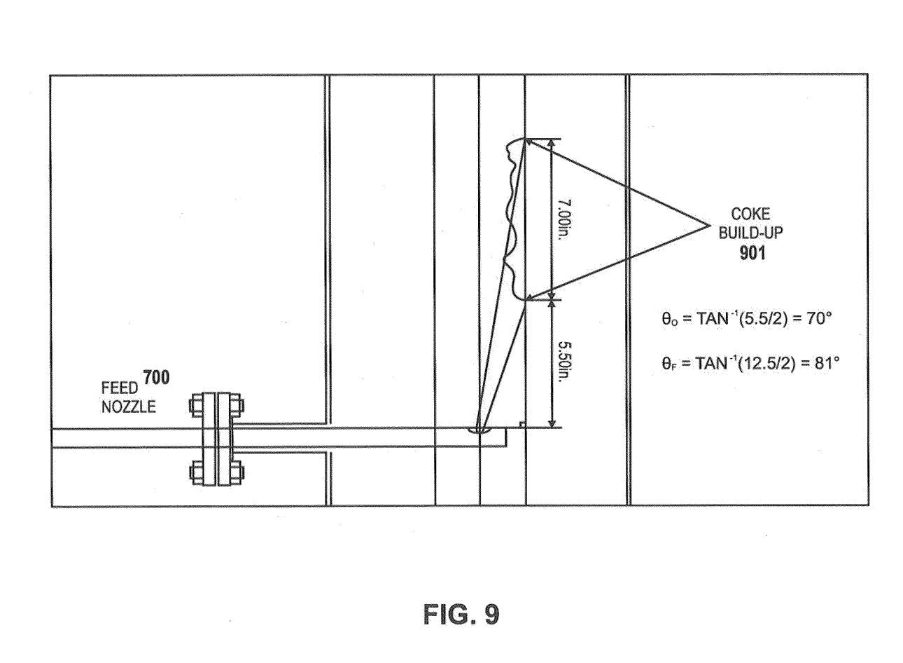

FIG. 9 illustrates the deficiencies caused by an uneven spray pattern produced by a prior art feed nozzle as depicted in FIGS. 7A-7D.

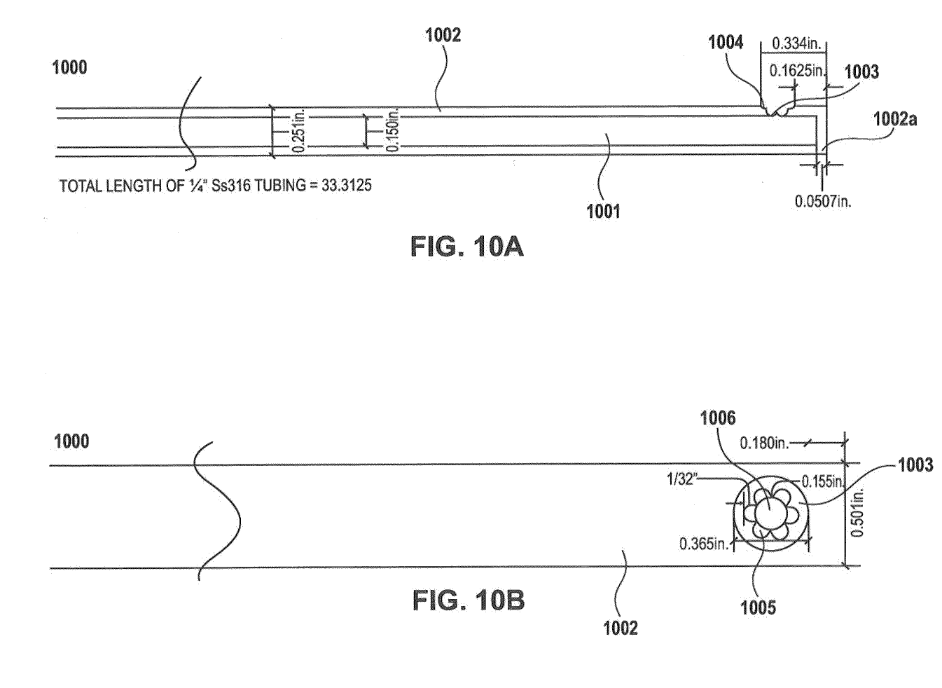

FIG. 10A illustrates a side view of an exemplary improved reactor feed nozzle, according to one embodiment.

FIG. 10B illustrates a front or top view of an exemplary improved reactor feed nozzle, according to one embodiment.

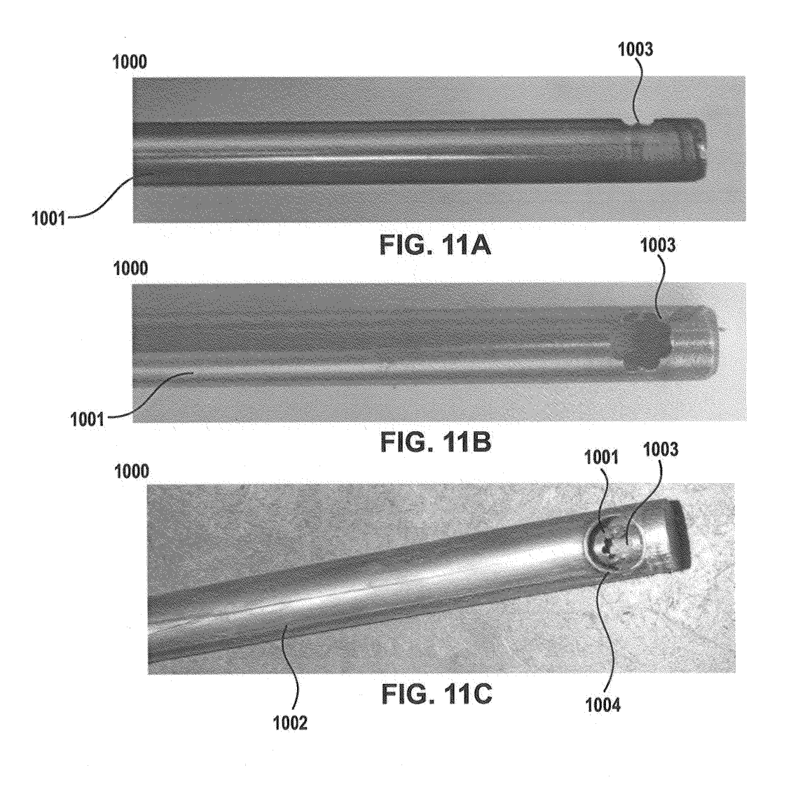

FIG. 11A illustrates a side view of an exemplary improved reactor feed nozzle inner tubing, according to one embodiment.

FIG. 11B illustrates a front or top view of an exemplary improved reactor feed nozzle inner tubing, according to one embodiment.

FIG. 11C illustrates a front or top view of an exemplary improved reactor feed nozzle with heat shield, according to one embodiment.

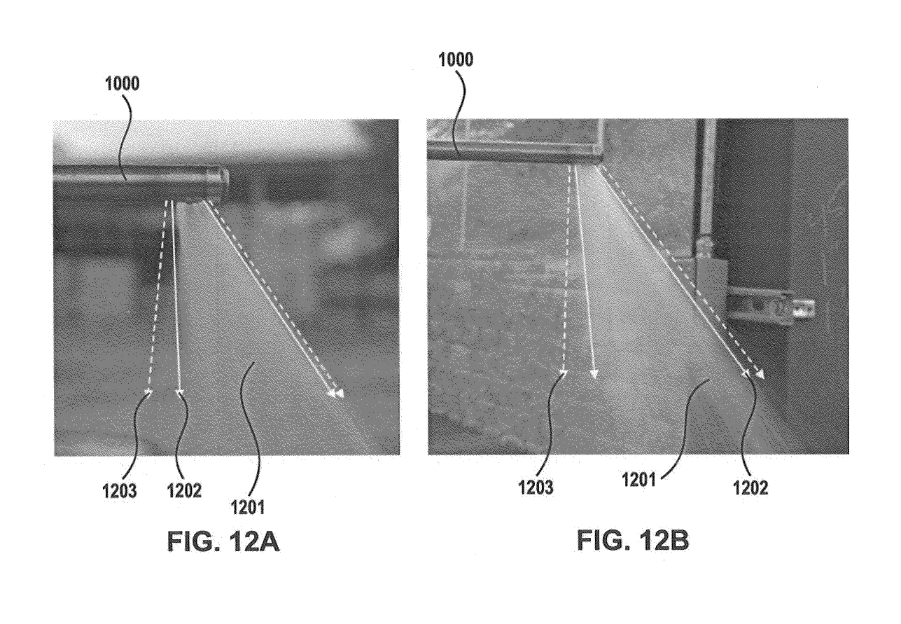

FIGS. 12A and 12B illustrate an analysis of an exemplary spray pattern produced by an exemplary improved reactor feed nozzle according to FIGS. 10A-11C.

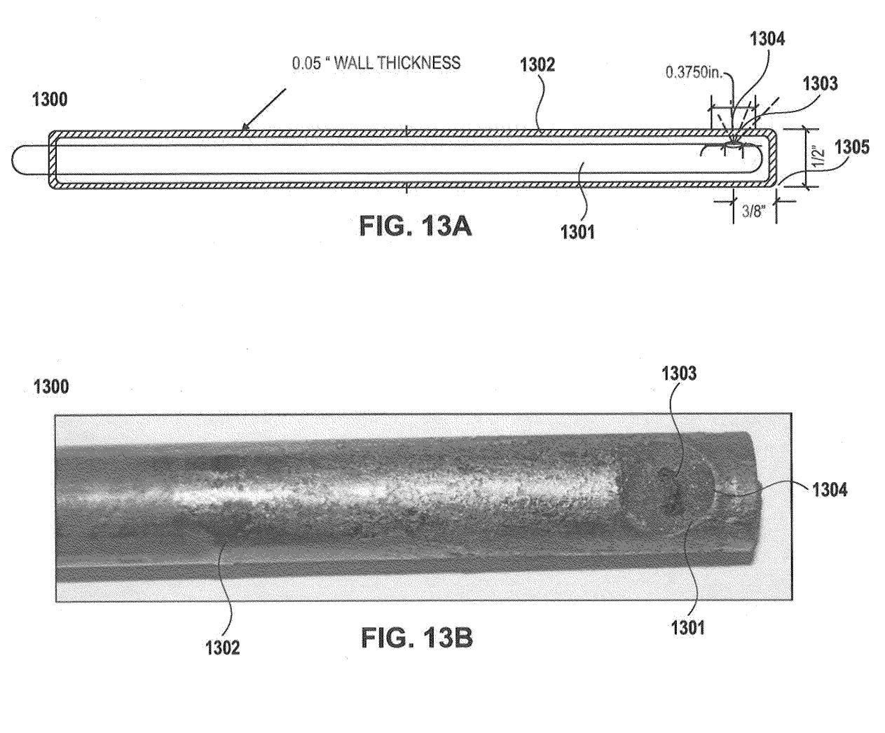

FIG. 13A illustrates a side view of an exemplary improved feed nozzle, according to one embodiment.

FIG. 13B illustrates a front or top view of an exemplary improved feed nozzle, according to one embodiment.

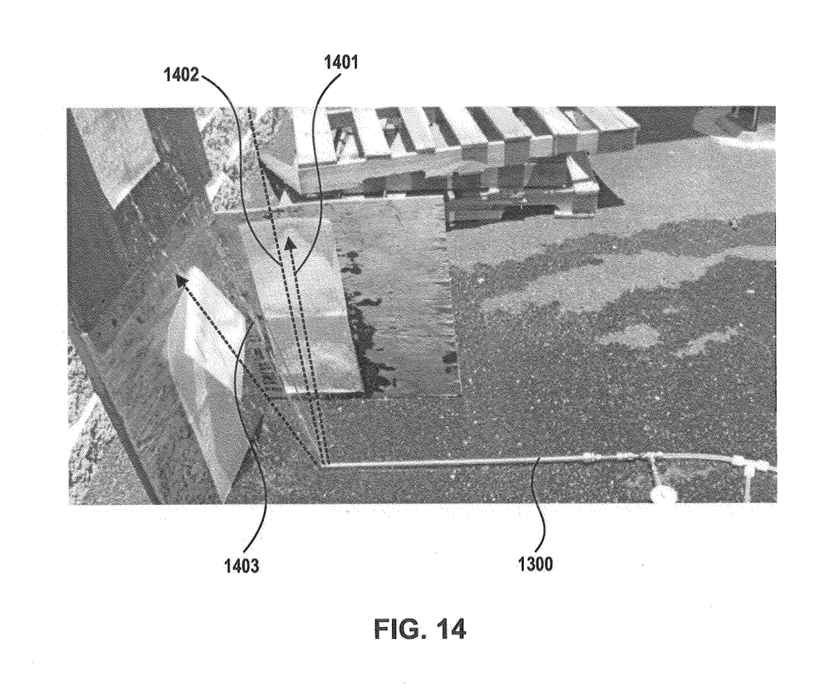

FIG. 14 illustrates a spray pattern of an exemplary reactor feed nozzle according to FIGS. 13A and 13B.

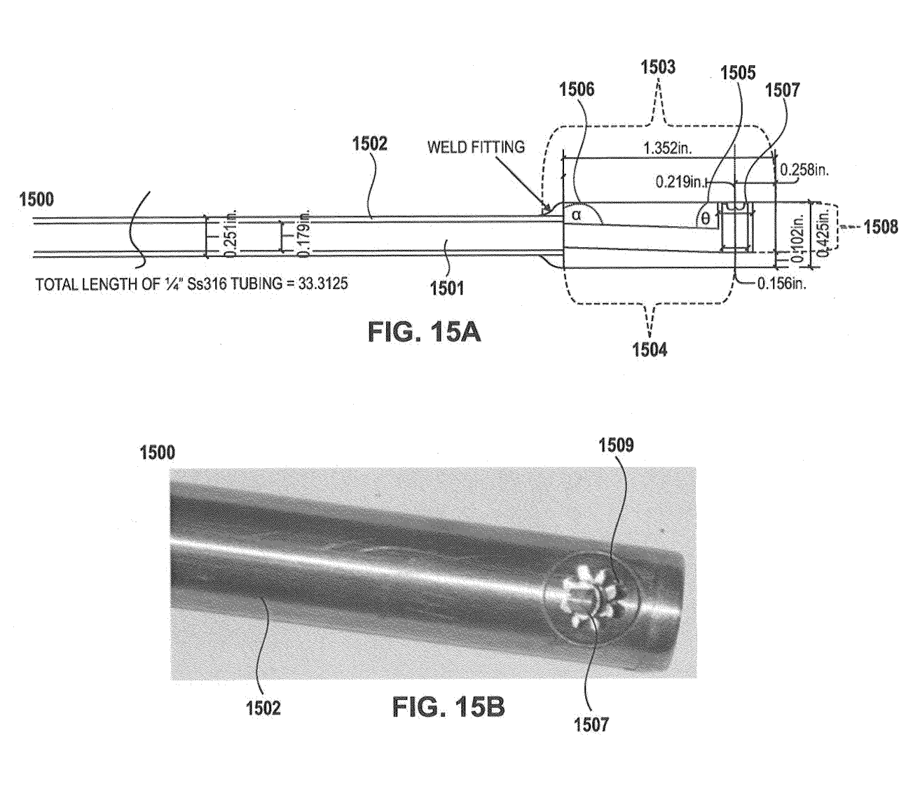

FIG. 15A illustrates a side view of a further exemplary improved reactor feed nozzle, according to one embodiment.

FIG. 15B illustrates a front or top view of a further exemplary improved reactor feed nozzle, according to one embodiment.

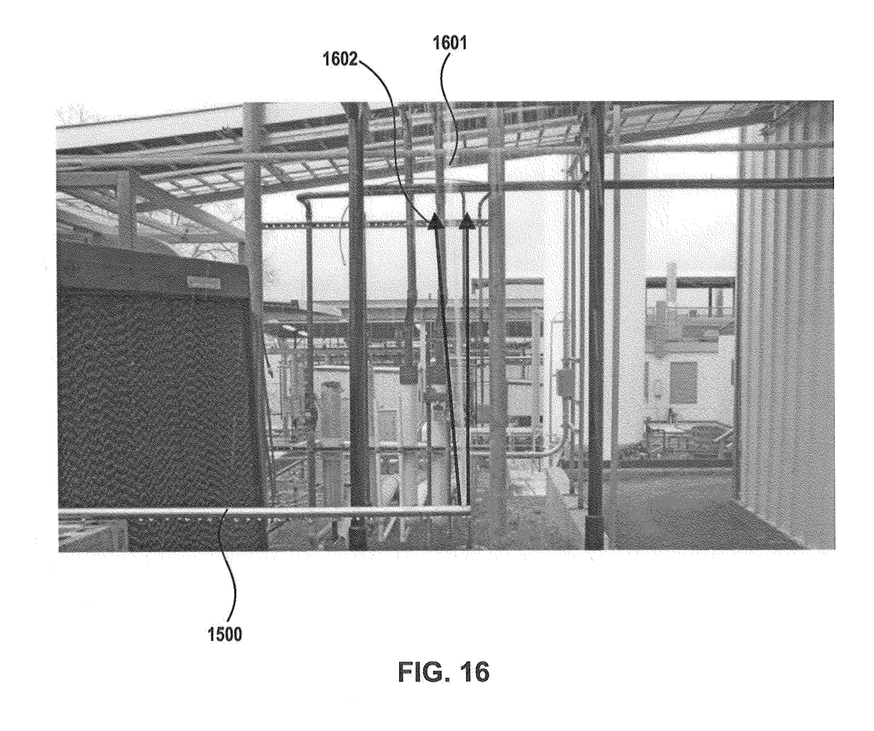

FIG. 16 illustrates a spray pattern of an exemplary reactor feed nozzle according to FIGS. 15A and 15B.

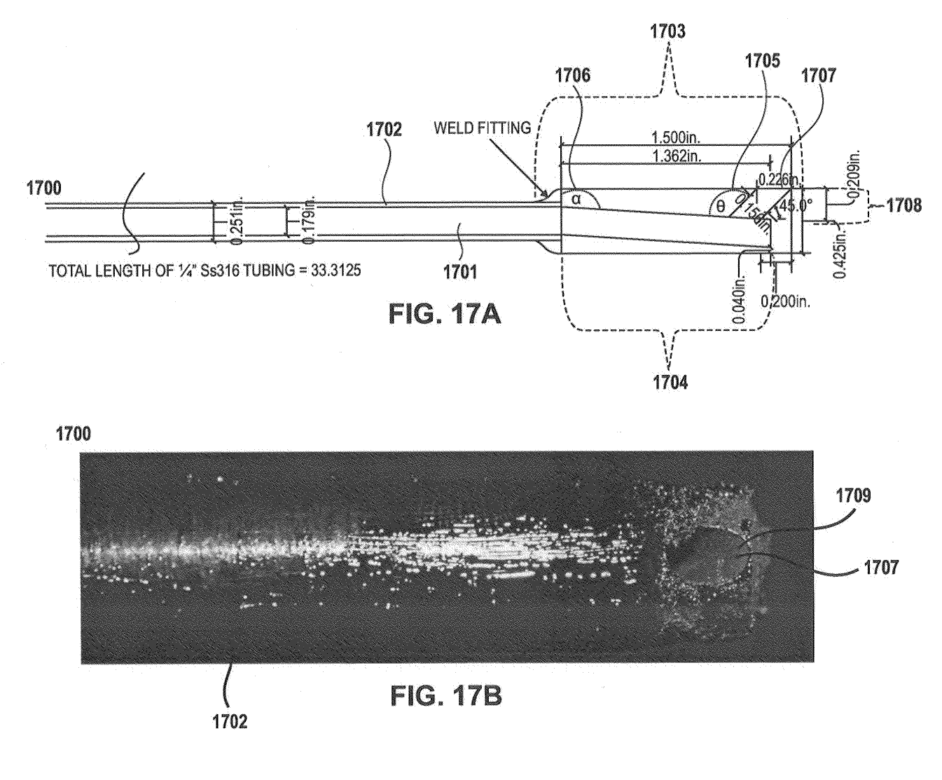

FIG. 17A illustrates a side view of a further exemplary improved reactor feed nozzle, according to one embodiment. FIG. 17B illustrates a front or top view of a further exemplary improved reactor feed nozzle, according to one embodiment.

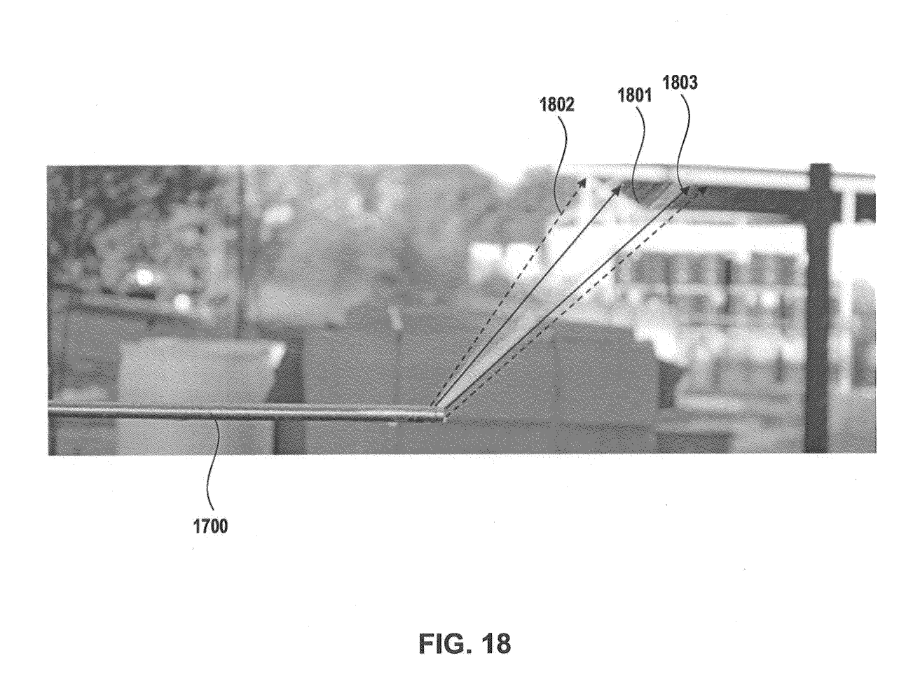

FIG. 18 illustrates a spray pattern of an exemplary reactor feed nozzle according to FIGS. 17A and 17B.

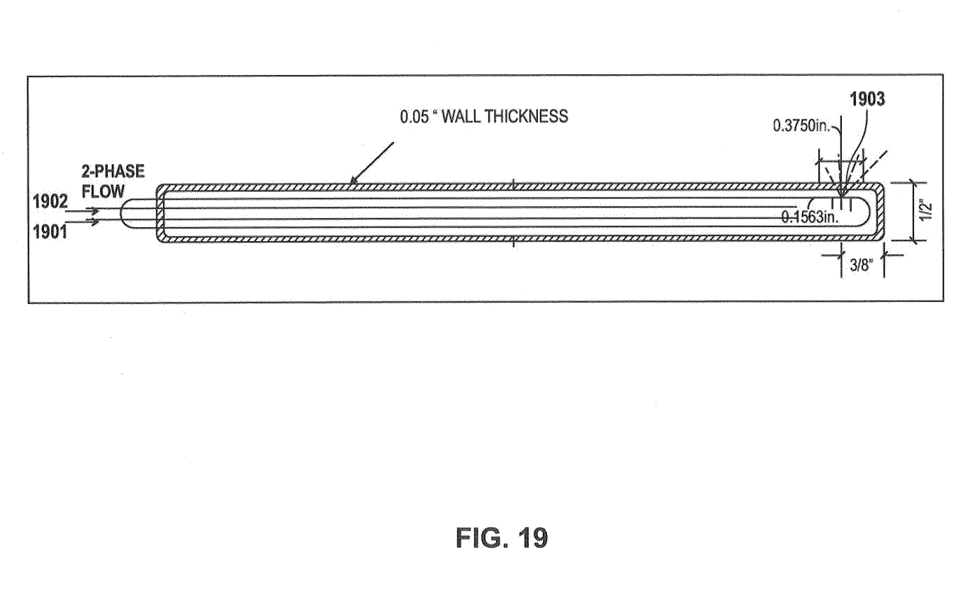

FIG. 19 illustrates a two phase flow of a prior art reactor feed nozzle.

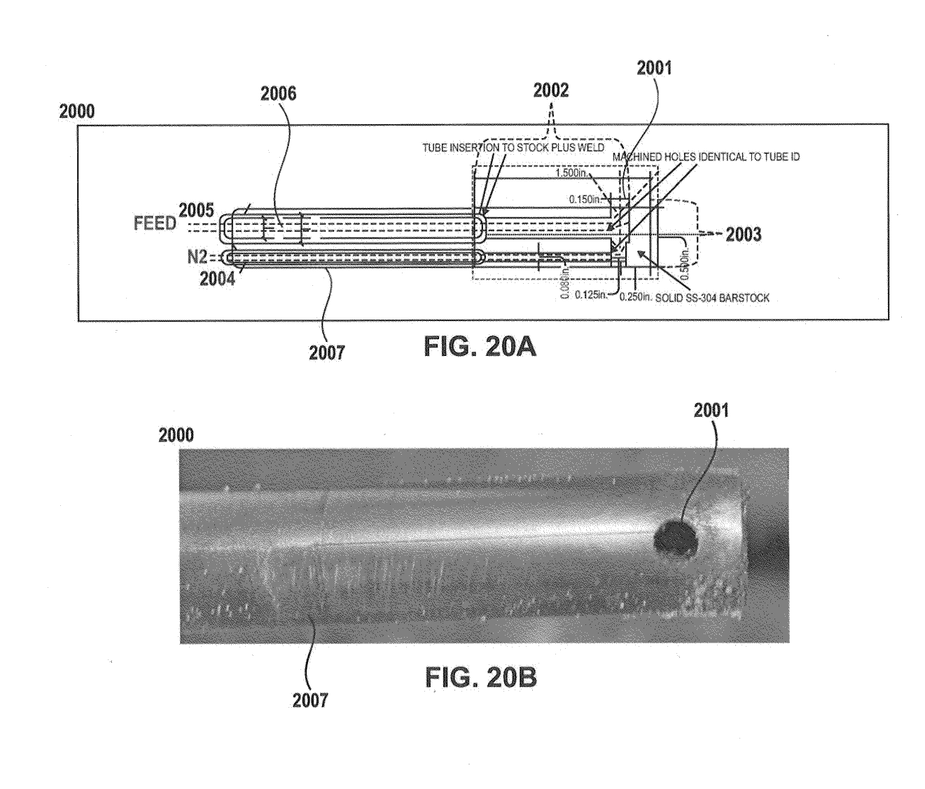

FIG. 20A illustrates a side view of a further exemplary improved reactor feed nozzle, according to one embodiment. FIG. 20B illustrates a front or top view of a further exemplary improved reactor feed nozzle, according to one embodiment.

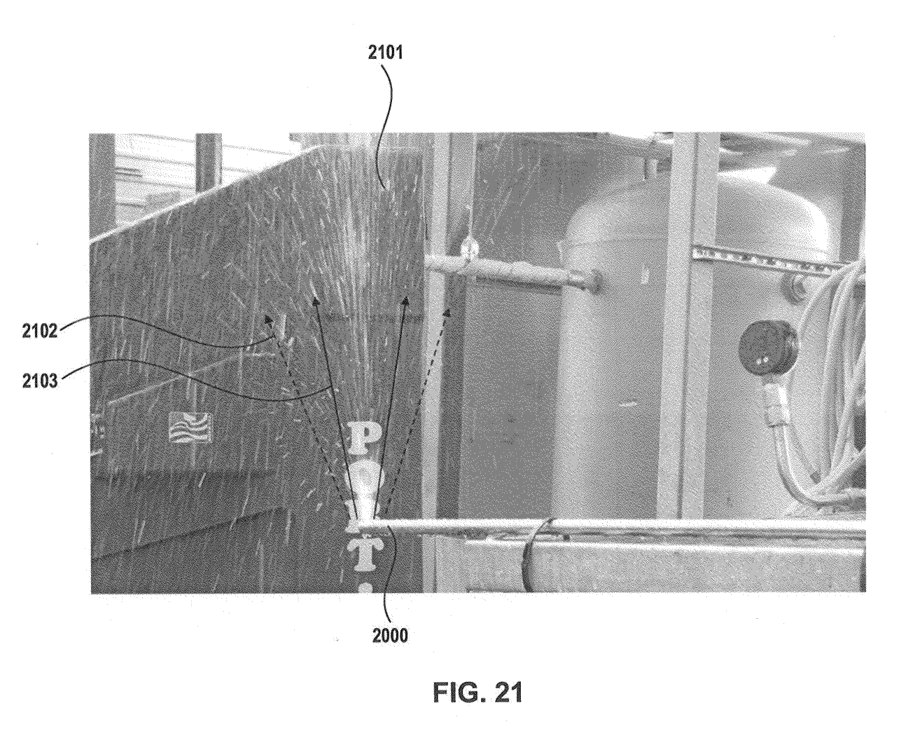

FIG. 21 illustrates a spray pattern of an exemplary reactor feed nozzle according to FIGS. 20A and 20B.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

Improved reactor feed nozzles are disclosed. According to one embodiment, a feed nozzle comprises an inner tubing encased within an outer heat shield tubing, a first circular hole fabricated in the inner tubing, the first circular hole having a first diameter and serving as a discharge hole, a second circular hole fabricated in the outer heat shield tubing, the second circular hole having a second diameter, wherein the second diameter is larger than the first diameter; and a welded tip for extending a flow path at a declining angle, the welded tip having a section extending at a predetermined angle from the inner tubing to the discharge hole.

The present disclosure provides an apparatus or injection nozzle assembly that is capable of producing an excellent, steady and smooth flow of a mixture of a gas, (e.g. a hydrogen-containing gas, product recycle gas, flue gas, nitrogen, carbon dioxide, and steam) and a liquid (e.g. a liquid hydrocarbon) into a reactor without the deficiencies associated with the prior art apparatuses, and a method for using the same. The purpose of the reactor is to convert a heavy oil feedstock into a lighter end product, via pyrolysis reaction (thermal cracking) inside a circulating bed, solid heat carrier transport reactor system.

The present disclosure further provides an improved injection nozzle that provides for uniform liquid distribution of feedstock in the reactor, such that there is an increase in the percentage of small droplet size in the droplet size distribution of the feedstock entering the reactor.

The present disclosure further provides an improved injection nozzle that provides for a homogeneous dispersed flow of material into the reactor and an improved injection nozzle that provides for an improved contact of solid heat carrier with a decrease in free coke formation from the injection nozzle through the reactor flow line.

The present invention accomplishes its desired objectives by providing an injection nozzle for rapid thermal processing and upgrading of viscous heavy hydrocarbon feedstocks. The injection nozzle includes a first tube member having a tubular bore and a structure defining at least one opening and at least one second tube member having a tubular bore and bound to the first tube member such that the tubular bore communicates with the at least one opening. The at least one tube member has a pair of open ends. The tube member has a tubular axis and the tubular opening which has one opening axis that is generally normal to the tubular axis and one opening that is perpendicular to the tubular axis. The present invention further accomplishes its desired objects by broadly providing a reactor comprising a vessel with an internal cylindrical wall and the distributor assembly is secured to the internal cylindrical wall of the vessel.

The injection nozzle of the present invention is utilized in the processes for upgrading heavy oil or bitumen feedstock involving a partial chemical upgrade or mild cracking of the feedstock. These processes also reduce the levels of contaminants within feedstocks, thereby mitigating contamination of catalytic contact materials such as those used in fluid catalytic cracking, hydrotreating, or hydrocracking, with components present in the heavy oil or bitumen feedstock. Such processes and/or methods and the related apparatuses and products are described in U.S. Pat. No. 7,572,365; U.S. Pat. No. 7,572,362; U.S. Pat. No. 7,270,743; U.S. Pat. No. 5,792,340; U.S. Pat. No. 5,961,786; U.S. Pat. No. 7,905,990; and pending U.S. patent application Ser. Nos. 12/046,363 and 09/958,261 incorporated herein by reference in their entirety.

As described in U.S. Pat. No. 5,792,340 (incorporated herein by reference in its entirety), for the present type of pyrolysis reactor system, a feed dispersion system is required for liquid feedstock. Transport gas (lift gas) is introduced to the reactor through a plenum chamber located below a gas distribution plate. The purpose of the feed dispersion system is to achieve a more efficient heat transfer condition for the liquid feedstock by reducing the droplet size of the liquid feed to increase the surface area to volume ratio. The purpose of the lift gas distribution plate (distributor plate) is to provide the optimum flow regime of gas to lift the solid heat carrier through the reactor and that facilitates the mixing of feed and solid heat carrier.

By “feedstock” or “heavy hydrocarbon feedstock”, it is generally meant a petroleum-derived oil of high density and viscosity often referred to (but not limited to) heavy crude, heavy oil, (oil sand) bitumen or a refinery resid (oil or asphalt). However, the term “feedstock” may also include the bottom fractions of petroleum crude oils, such as atmospheric tower bottoms or vacuum tower bottoms. Furthermore, the feedstock may comprise significant amounts of BS&W (Bottom Sediment and Water), for example, but not limited to, a BS&W content of 0.5 wt %. Heavy oil and bitumen are preferred feedstocks. Embodiments of the invention can also be applied to the conversion of other feedstocks including, but not limited to, plastics, polymers, hydrocarbons, petroleum, coal, shale, refinery feedstocks, bitumens, light oils, tar mats, pulverized coal, biomass, biomass slurries, and biomass liquids from any organic material and mix. Preferably, the biomass feedstock is a dry wood feedstock, which may be in the form of sawdust, but liquid and vapor-phase (gas-phase) biomass materials can be effectively processed in the rapid thermal conversion system using an alternative liquid or vapor-phase feed system. Biomass feedstock materials that may be used include, but are not limited to, hardwood, softwood, bark, agricultural and silvicultural residues, and other biomass carbonaceous feedstocks.

FIG. 1 illustrates a prior art reactor design. The reactor design 100 includes a tubular reactor 101 where recirculation or lift gas 102 enters at a lowest point 102a. Regenerated solid heat carrier 103 enters at a slightly higher point 103a, and reactor feed liquid 104 is introduced at a highest point 104a. Coked/spent solid heat carrier, products, and other gases and particulates 105 emanated from the top of the reactor enter a cyclone separator 106, where the gases (product vapor and other gases) and solids (solid heat carrier and particulates) separate. The product vapor and other gases continue on downstream of the process for further separation of products 107. The stream of solids 108 enters a reheater system 109 (reheater system 109 not depicted in figure but inclusion in system will be appreciated by one of ordinary skill in the art). The solid heat carrier gets regenerated, and then passes through a lateral section to transport the regenerated solid heat carrier 103 back to the reactor 101.

FIG. 2 illustrates an exemplary reactor design for use with the present system, according to one embodiment. Similar to the prior art reactor 100 depicted in FIG. 1, reactor 200 design includes a tubular reactor 201 where recirculation or lift gas 202 enters at a lowest point 202a. Regenerated solid heat carrier 203 enters the reactor 200 at a slightly higher point 203a. Reactor feed liquid 204 is introduced through a feed nozzle 204b at a highest point 204a in relation to the entry points of the lift gas (202a) and solid heat carriers (203a). Coked/spent solid heat carrier, products, and other gases and particulates 205 emanated from the top of the reactor enter a cyclone separator 206, where the gases (product vapor and other gases) and solids (solid heat carrier and particulates) separate. The product vapor and other gases continue on downstream of the process for further separation of products 207. The solids re-enter the reactor system 208, the solid heat carrier get regenerated, and then a lateral section transports the regenerated solid heat carrier 203 back to the reactor. It will be appreciated by one of ordinary skill in the art that the specific methods for solid heat carrier regeneration and transport back to the reactor may have variations between embodiments without departing from the scope of the present disclosure.

Performance of the prior art reactor design 100 depicted in FIG. 1 can be evaluated by properties that indicate the effectiveness of a particular equipment configuration. The properties illustrate the distribution of feed material into both desirable and less desirable products, as well as physical properties of the final product. The desirable resulting products include any hydrocarbon liquid that remains from the thermal cracking process, because the liquid can be recovered to be blended into the final product, or get reprocessed. Meanwhile, the coke and gas are less desirable lower value materials that replace natural gas for generation of steam, or electricity, depending on the location.

A setup using the prior art design 100 that processed Athabasca Bitumen feedstock included the reactor temperature set at 525° C. (typical operating temperature), Athabasca Bitumen whole crude Vanadium content: 209 ppm and run product Vanadium content: 88 ppm, and Athabasca Bitumen whole crude Nickel content: 86 ppm and run product Nickel content: 24 ppm. Table 1 illustrates the obtained properties.

TABLE 1
Properties of prior art reactor design
Athabasca Bitumen run at 525° C.

| | Liquid | Viscosity | Vanadium | Nickel |
|---|---|---|---|---|
| | Yield | at 40° C. | Removal | Removal |
| API | (wt %) | (cSt) | (wt %) | (wt %) |
| 12.9 | 74.4 | 201 | 68.7 | 79.2 |

The properties shown in Table 1 serve as a baseline for design comparisons throughout the present disclosure, with emphasis on the reactor feed nozzles. It will be appreciated that the baseline is for a point of reference from U.S. Pat. No. 7,572,365, and not necessarily for direct comparisons.

FIG. 3 illustrates an exemplary reactor configuration for use with the present system, according to one embodiment. The reactor 301 is a vertical tubular vessel having a top end 301b and a bottom end 301a. Recycled product gas (lift gas) 302 is designed to enter the reactor at a lowest point 302a from the very bottom 301a. Regenerated solid heat carrier 303 enters the reactor 301 at a slightly higher position 303a, and finally heavy oil feed 304 enters the reactor 301 through a feed nozzle 304b at a point 304a above the solid heat carrier entrance 303a.

The lift gas first exits the piping into the windbox 305, a short cylindrical structure with a bottom bowl built directly underneath the tubular reactor 301. According to one embodiment, the windbox cylinder 305 spans a diameter of 14 inches, and is connected via flanges 307 and 308 to the bottom 301a of the tubular reactor 301, which is 4 inches in diameter. A distributor plate 306 is located between the reactor bottom 301a and the windbox 305, and is held together by the flanges 307 and 308. As the lift gas 302 exits the windbox 305, it passes through the distributor plate 306, and into the 4″ diameter reactor 301. The distributor plate 306 modifies the flow characteristics of the lift gas 302 entering the reactor 301, through the configurations of holes in the distributor plate 301.

FIGS. 4 and 5 illustrate a prior art feed nozzle design. FIG. 6 illustrates a bottom view of a prior art feed nozzle configuration within a reactor. A prior art feed nozzle design 400 includes a feed nozzle 401 inserted horizontally into a tubular reactor 201. The feed nozzle 401 is positioned perpendicular (a right angle or 90 degrees) to a vertical flow direction of lift gas and solid heat carrier 402. The feed nozzle 401 extends a distance of approximately a radius of the reactor 201. Feed exits the feed nozzle 401 creating a feed spray 403, and a portion 404 of the feed spray 403 that does not come in contact with the solid heat carrier comes in contact with a reactor 201 wall opposite the feed nozzle 401.

FIG. 7A illustrates a side view of a prior art feed nozzle. FIG. 7B illustrates a front or top view of a prior art feed nozzle. A prior art feed nozzle 700 includes a 0.25 (¼″) inch outside-diameter (OD) and 0.15 (0.05″ wall thickness) inside-diameter (ID) stainless steel closed-end tubing 701. The ¼″ tubing 701 is encased in a heat shield 702. The heat shield 702 is a larger closed-end tubing that has a 0.5 inch OD and 0.4 inch ID (0.05″ wall thickness). At 0.375 (⅜″) inches from the end of the outer tubing, a 0.1563 ( 5/32″) inch diameter hole 703 is fabricated on the inner tubing 701 to serve as the nozzle discharge hole 703, and a 0.375 (⅜″) inch diameter hole 704 is fabricated on the heat shield 702, directly above the nozzle discharge hole 703. The shapes of both inner 703 and outer holes 704 are circular. FIG. 7C illustrates a prior art feed nozzle inner tubing without a heat shield, and FIG. 7D illustrates a prior art feed nozzle heat shield.

One method of evaluating performance of a feed nozzle for the reactor is to evaluate its ability to disperse feed material to solid heat carrier particles. Rough evaluation of the performance is achieved by observing a spray pattern of a stream of liquid discharged from a feed nozzle.

FIGS. 8A and 8B illustrate a spray pattern produced by a prior art feed nozzle design depicted in FIGS. 7A-7D.

As observed in FIGS. 8A and 8B, the liquid discharge stream from feed nozzle 700 exhibits a general spray pattern that is approximately conical-shaped. The general spray pattern indicates that the nozzle 700 is able to adequately disperse the liquid to finer droplets, given a sufficient volume for the liquid to expand as it travels further away from the nozzle 700. Upon closer inspection, it can be observed that the bulk of the liquid discharge stream is concentrated near the front half of the general spray pattern (cone). Dotted lines outline the general spray stream 801, and the solid lines outline the bulk liquid spray stream 802.

While the nozzle 700 is able to disperse the liquid stream, the nozzle 700 sprays more liquid towards the reactor wall in the side opposite to the feed nozzle port. This is likely due to the fact that the flow of liquid through the nozzle 700 is horizontal until the liquid exits the nozzle 700 through the discharge hole 704 at the side of the nozzle 700 conduit, without passing any section that can redirect the flow vertically.

FIG. 9 illustrates the deficiencies caused by an uneven spray pattern produced by a prior art feed nozzle as depicted in FIGS. 7A-7D. Measurements of solids build-up 901 taken to illustrate the spray pattern of prior art feed nozzle 700. It is known that a coating of fine solids deposited from feed oil material on the reactor wall causes subsequent accumulation of solids and reaction products. Thus, it is desirable to reduce any direct contact of feed and reactor wall surfaces. While the prior art feed nozzle 700 is able to disperse the feed oil material into smaller droplets, which facilitates mixing and heat transfer with the fluidized solid heat carrier particles, it does so by broadcasting dispersed liquid droplets to a large volume. Given the limited volume available inside the exemplary 4 inch inside-diameter reactor, a substantial amount of feed oil with fine solid material is sprayed onto the reactor wall.

Another method of evaluating the performance of a feed nozzle is to determine the droplet size of the liquid discharge from the nozzle. For this purpose, an investigation on the parameters that describe the dispersion of the feed to the reactor using nitrogen was carried out by using water and N₂ gas at ambient conditions. Each experiment run produced a characteristic droplet size distribution. The correlation of El-Shanawany and Lefebvre, for two phase flow in spray-nozzles (most representative of the nozzle 700), was used to calculate the main parameters of the respective droplet size distribution. The data used and the results of water droplet size distribution are shown in Table 2.

In order to describe the spectrum of droplets seen in the test runs, the Chi-squared distribution is commonly used in experiments in this kind.

TABLE 2
Nozzle 700 water droplet size distribution data and results

| | | | | | Dvm Vol | Dmax |
|---|---|---|---|---|---|---|
| | | | N₂ | D32 Sauter | Median | Droplet |
| | | Water | Flow, | Droplet | Droplet | Max |
| P, psig | T, C. | Flow, lb/h | lb/h | Diam, μm | Diam, μm | Diam, μm |
| 15 | 25 | 40.1 | 2.0 | 556 | 741 | 1852 |
| 15 | 25 | 65.2 | 2.0 | 538 | 717 | 1793 |
| 15 | 25 | 50.2 | 3.0 | 233 | 311 | 778 |
| 15 | 25 | 50.2 | 4.0 | 127 | 170 | 424 |
| 15 | 25 | 35.1 | 4.0 | 129 | 172 | 429 |
| 30 | 25 | 75.2 | 2.0 | 622 | 829 | 2072 |
| 30 | 25 | 80.3 | 2.0 | 616 | 821 | 2053 |
| 30 | 25 | 70.2 | 3.0 | 273 | 364 | 910 |
| 30 | 25 | 100.3 | 3.0 | 263 | 350 | 876 |
| 30 | 25 | 70.2 | 3.0 | 273 | 364 | 910 |
| 30 | 25 | 100.3 | 4.0 | 146 | 195 | 488 |
| 30 | 25 | 70.2 | 4.0 | 151 | 201 | 502 |
| 30 | 25 | 95.3 | 4.0 | 147 | 196 | 490 |

Using the water droplet size distribution data as a basis, the droplet size distribution of Athabasca Bitumen oil is extrapolated, by applying the viscosity and surface tension of Athabasca Bitumen at reactor conditions. Also, since the feed is injected at high velocities and the bulk fluid has little heat transfer area to exchange heat with its surroundings until it is sprayed, a temperature of 250° C. was taken as average to evaluate properties of the Athabasca Bitumen and nitrogen. The data used and the results for Athabasca Bitumen oil droplet size distribution are shown in Table 3.

TABLE 3
Nozzle 700 Athabasca Bitumen oil droplet size distribution data and results

| | | | | | Oil | | | |
|---|---|---|---|---|---|---|---|---|
| | | | | Oil | surface | | Dvm | |
| | | | | Viscosity | tension | D32 | Vol | Dmax |
| | | | | at | at | Sauter | Median | Droplet |
| | | Oil | N₂ | Reactor | Reactor | Droplet | Droplet | Max |
| P | | Flow, | Flow, | Conditions, | Conditions, | Diam, | Diam, | Diam, |
| psig | T, C. | lb/h | lb/h | cP | dyne/cm | μm | μm | μm |
| 15 | 250 | 40.1 | 2.0 | 13.5 | 18.1 | 754 | 1005 | 2513 |
| 15 | 250 | 65.2 | 2.0 | 13.5 | 18.1 | 730 | 973 | 2433 |
| 15 | 250 | 50.2 | 3.0 | 13.5 | 18.1 | 317 | 422 | 1056 |
| 15 | 250 | 50.2 | 4.0 | 13.5 | 18.1 | 173 | 230 | 576 |
| 15 | 250 | 35.1 | 4.0 | 13.5 | 18.1 | 175 | 233 | 582 |
| 30 | 250 | 75.2 | 2.0 | 13.5 | 18.1 | 843 | 1124 | 2811 |
| 30 | 250 | 80.3 | 2.0 | 13.5 | 18.1 | 836 | 1114 | 2785 |
| 30 | 250 | 70.2 | 3.0 | 13.5 | 18.1 | 370 | 494 | 1234 |
| 30 | 250 | 100.3 | 3.0 | 13.5 | 18.1 | 357 | 475 | 1189 |
| 30 | 250 | 70.2 | 3.0 | 13.5 | 18.1 | 370 | 494 | 1234 |
| 30 | 250 | 100.3 | 4.0 | 13.5 | 18.1 | 199 | 265 | 662 |
| 30 | 250 | 70.2 | 4.0 | 13.5 | 18.1 | 204 | 272 | 681 |
| 30 | 250 | 95.3 | 4.0 | 13.5 | 18.1 | 199 | 266 | 665 |

It was determined from particle size analysis that the solid heat carrier (Ottawa F-17 sand) used in the process is approximately 360 microns on average (Sauter diameter). Out of the common run conditions (feed flow rate of between 30 and 60 lb/hr, and N₂ flow of 2 to 4 lb/hr) shown in Table 3, nozzle 700 is able to produce droplet sizes smaller than the solid heat carrier size with flow rates of 50.2 lb/hr and 35.1 lb/hr, with 3 lb/hr and 4 lb/hr of dispersion nitrogen flow. However, for the most common run conditions (N₂ flow of 2 lb/hr), nozzle 700 is only able to produce droplets with twice the diameter of the solid heat carrier.

In theory, for thermal cracking purposes, smaller droplet size in relation to solid heat carrier size results in more efficient heat transfer. This is due to the higher surface area to volume ratio of each droplet, as well as the greater likelihood for each solid heat carrier particle to interact with multiple substrates (droplet). Table 4 demonstrates this theory.

TABLE 4
Effect of feed dispersion

| Parameters | Case 1 | Case 2 | Case 3 |
|---|---|---|---|
| Oil droplet size, micron | 500 | 100 | 30 |
| Relative nos. of droplets | 1 | 125 | 4630 |
| Oil drops per catalyst particle | 0.001 | 0.11 | 4 |
| Vaporization time, mili sec | | | |
| @ 50% vaporization | 220 | 11 | 4 |
| @ 50% vaporization | 400 | 20 | 8 |

To maximize the efficiency of the thermal cracking process, it is favorable to maximize the mixing of the reactor feed oil with the fluidized solid heat carrier particles, and at the same time reduce the spraying of reactor feed oil with fine solids onto the inside wall of the reactor. Therefore, feed nozzles are disclosed herein such that the general direction of the reactor feed oil discharge is parallel to the flow direction of the fluidized solid heat carrier (upward through the vertical tubular reactor), with the point of discharge (feed oil entry) located at the center of a reactor cross-section.

FIG. 10A illustrates a side view of an exemplary improved reactor feed nozzle, according to one embodiment. FIG. 10B illustrates a front or top view of an exemplary improved reactor feed nozzle, according to one embodiment. An improved reactor feed nozzle 1000 includes a stainless steel closed-end inner tubing 1001 having an outside diameter (OD) and an inside diameter (ID). The inner tubing 1001 is encased in a heat shield 1002. The heat shield 1002 has an outside diameter (OD₂) and an inside diameter (ID₁) and is a larger closed-end tubing than the inner tubing 1001. At a predetermined length from an end 1002a of the outer tubing or heat shield 1002, a hole 1003 having a diameter dᵢ is fabricated on the inner tubing 1001 to serve as the nozzle 1000 discharge hole. A hole 1004 having a diameter dₒ is fabricated on the heat shield 1002 directly above the nozzle discharge hole 1003.

The discharge hole 1003 also consists of 8 semi-circular holes 1005 (or “petals”) having a diameter dₕ (in this example 0.03125 ( 1/32″) inch in diameter), fabricated around a 0.1563 inch diameter (as an example) circular hole 1006, to form a final nozzle discharge hole 1003 shape that resembles a clover with a uniform distribution of 8 petals (in this example). The clover shape nozzle discharge hole 1003 is designed to use the jagged edges of the clover to create liquid dispersion.

FIG. 11A illustrates a side view of an exemplary improved reactor feed nozzle inner tubing, according to one embodiment. FIG. 11B illustrates a front or top view of an exemplary improved reactor feed nozzle inner tubing, according to one embodiment. FIG. 11C illustrates a front or top view of an exemplary improved reactor feed nozzle with heat shield, according to one embodiment.

FIGS. 12A and 12B illustrate an analysis of an exemplary spray pattern produced by an exemplary improved reactor feed nozzle according to FIGS. 10A-11C.

The liquid discharge stream from the nozzle 1000 exhibits a general spray pattern 1201 that resembles an irregular cone that extends outward away from the tip of the nozzle 1000. There is a wider general spray volume that is covered by the entire volume of liquid discharge from the nozzle 1000, and a narrower spray volume that consist of the bulk of the liquid discharge stream. For the improved nozzle 1000, the general spray stream 1202 (dotted lines) is only slightly wider than the bulk spray stream (solid lines) 1203, thus more liquid is contained within or near the bulk spray stream 1203. However, the liquid within the bulk spray stream 1203 appears to be adequately and uniformly dispersed. This may be attributed to the clover shaped nozzle discharge hole, where the enlarged hole area provide less wide-spreading liquid dispersion due to the orifice nozzle effect, while the jagged edges of the clover breaks up the bulk liquid stream. The uniform dispersion contributes to the dispersion of a greater percentage of feed liquid into a smaller droplet size, which is favored in a thermal cracking setup due to more efficient heat transfer.

With less liquid at the periphery 1202 of the bulk spray stream, the improved feed nozzle 1000 potentially sprays less fine solids from liquid feedstock to the side of the reactor inside wall. However, this is offset by the fact that the nozzle 1000 also sprays much of the discharge liquid towards the reactor wall in the side opposite to the feed nozzle port, due to the irregular cone spray pattern. Spraying heavy oil feedstock to the reactor inside wall is undesirable in the reactor system, because the fine solids from the feedstock are caught by microscopic striations on the wall become immobilized and accumulate, and build up with increasing size solids that eventually include some reaction products.

FIG. 13A illustrates a side view of an exemplary improved feed nozzle, according to one embodiment. FIG. 13B illustrates a front or top view of an exemplary improved feed nozzle, according to one embodiment. An exemplary feed nozzle 1300 includes a stainless steel inner tubing 1301 (in this example having a 0.25 inch OD and a 0.15 inch ID) encased in a stainless steel heat shield 1302 (in this example having a 0.5 inch OD and a 0.4 inch ID). At a predetermined length (in this example ⅜ inches) from an end 1305 of the outer tubing or heat shield 1302, a circular hole 1303 (in this example having a diameter of 0.0938 inches) is fabricated on the inner tubing 1301 to serve as the nozzle discharge hole. A circular hole 1304 (in this example having a 0.375 inch diameter) is fabricated on the heat shield 1302, directly above the nozzle discharge hole 1303.

FIG. 14 illustrates a spray pattern of an exemplary reactor feed nozzle according to FIGS. 13A and 13B. FIG. 14 illustrates that the liquid discharge stream 1403 from nozzle 1300 exhibits a general spray pattern 1401 with a narrow bulk liquid stream that shows little dispersion, with a wider general spray stream consisting of slugs of liquid without much fine dispersion. The flow path 1401 of liquid discharge from nozzle 1300 is not completely vertical (perpendicular to the ground), but angled to flow away from the tip of the nozzle. A vertical line 1402 perpendicular to the ground is shown for reference purposes.

The nozzle 1300 provides little dispersion of liquid, but there is a possibility of low flow rate. Low flow rate reduces the turbulence of liquid through the nozzle discharge, and allows the liquid to enter the reactor environment without much breaking up. The flow stream 1403 is also narrow, likely due to the smaller discharge hole, which creates a higher superficial velocity of liquid through the discharge hole. With the bulk of the liquid stream able to maintain the momentum upwards longer, due to higher velocity, the bulk liquid stream stays intact to a greater height before much dispersion occurs. The nozzle 1300 also sprays more liquid towards the reactor wall in the side opposite to the feed nozzle port. This is likely due to the fact that the flow of liquid through the nozzle 1300 is horizontal until the liquid exits the nozzle through the discharge hole at the side of the nozzle conduit, without passing any section that can redirect the flow.

FIG. 15A illustrates a side view of a further exemplary improved reactor feed nozzle, according to one embodiment. FIG. 15B illustrates a front or top view of a further exemplary improved reactor feed nozzle, according to one embodiment. An exemplary nozzle 1500 includes a stainless steel inner tubing 1501 (in this example having a 0.25 inch OD and a 0.179 inch ID), the stainless steel inner tubing 1501 is encased in a stainless steel heat shield 1502. The nozzle 1500 has a welded tip 1503 that extends a horizontal flow path of the nozzle 1501 at a slight decline 1504 (angled at a 1506) to a length of the welded tip 1503 (in this example the length being 0.258 inches). The flow path then makes a turn at an angle θ 1505 (in this example θ=90° into a short vertical section 1508 before exiting a nozzle discharge hole 1507. The vertical section 1508 directs the liquid discharge stream toward the center of the reactor tube, while the slight decline 1504 of the horizontal flow path creates distance to maximize the length of the vertical section 1508.

The vertical section 1508, up to the discharge hole 1507, has a diameter (in this example 0.1563). The discharge hole 1507 is shaped into an 8-sided star pattern 1509. The star-shaped 1509 discharge hole 1507 creates dispersion to the liquid stream to compensate for the more condensed jet stream created by the vertical section 1508.

FIG. 16 illustrates a spray pattern of an exemplary reactor feed nozzle according to FIGS. 15A and 15B. FIG. 16 illustrates that, due to the vertical section 1508 at the nozzle 1500 tip, the spray direction 1601 produced by the nozzle 1500 is very close to being completely perpendicular to the ground. However, also due to the vertical section 1500, which acts as a flow-straightener, the spray pattern 1602 produced by the nozzle 1500 is narrow, without much signs of liquid dispersion at the periphery of the bulk liquid jet.

FIG. 16 illustrates that the spraying of feed oil material onto the reactor inside walls would be minimal when using the nozzle 1500. The combination of a more vertical and narrower flow stream allows more time for more of the feed oil material to be away from the reactor walls, thus increasing the likelihood of mixing between the feed oil material and the fluidized solid heat carrier. However, the narrow, condensed jet of liquid exiting the nozzle 1500 may not be thermally cracked in the most efficient manner, due to the apparent lack of liquid dispersion to produce small droplet sizes.

FIG. 17A illustrates a side view of a further exemplary improved reactor feed nozzle, according to one embodiment. FIG. 17B illustrates a front or top view of a further exemplary improved reactor feed nozzle, according to one embodiment. An exemplary nozzle 1700 includes a stainless steel inner tubing 1701 (in this example having a 0.25 inch OD and a 0.150 inch ID) encased in a stainless steel heat shield 1702. The nozzle 1700 includes a welded tip 1703 extending the horizontal flow path of the nozzle 1700 down a slight decline 1704 (angled at a 1706). The flow path then makes a turn at an angle θ 1705 (in this example θ=45° before exiting a nozzle discharge hole 1707. The diagonal section 1708, up to the discharge hole 1707, has a diameter (in this example having a diameter of 0.1563 inches). Because the diagonal section 1708 ends at a 45° angle (θ 1705), the discharge hole 1707 is oval-shaped 1709. The diagonal section 1708 directs the liquid discharge stream toward the reactor inside wall opposite to the nozzle 1700, while the slight decline 1704 of the horizontal flow path creates distance to maximize the length of the diagonal section 1708.

Due to the spray path created by the nozzle 1700, there can be increased distance between the reactor wall and the nozzle discharge hole 1707, to minimize the spraying of liquid feedstock into the wall. Therefore, only the very front of the nozzle 1700, where the discharge hole 1707 is located, actual protrudes into the reactor.

FIG. 18 illustrates a spray pattern of an exemplary reactor feed nozzle according to FIGS. 17A and 17B. FIG. 18 illustrates that the nozzle 1700 creates an overall narrow spray pattern 1803 and a general spray direction 1802 having an approximately 45° angle to the horizon. This can be attributed to the flow-straightening effect of the diagonal section 1708, as well as the circular discharge hole 1707. There are signs of dispersion of liquid discharged 1801 from the nozzle 1700, as the liquid is further away from the discharge point. In combination with the placement of the nozzle discharge hole 1707 as far away from the opposite wall as possible, which maximizes the horizontal travel distance of the liquid stream, the nozzle 1700 setup potentially creates a high degree of mixing for the feed and solid heat carrier.

FIG. 19 illustrates a two phase flow of a prior art reactor feed nozzle. An exemplary nozzle 2000 depicted in FIGS. 20A and 20B eliminates multi-phase flow. In the cases of prior art feed nozzles, simultaneous flow of liquid (feed oil material) and gas (N₂ gas) inside the feed nozzle causes at least two-phase flow as is illustrated in FIG. 19. N₂ gas is injected 1901 into the feed oil flow stream 1902 well before the discharge hole 1903.

FIG. 20A illustrates a side view of a further exemplary improved reactor feed nozzle, according to one embodiment. FIG. 20B illustrates a front or top view of a further exemplary improved reactor feed nozzle, according to one embodiment. The nozzle 2000 eliminates early mixing of feed oil and N₂ gas by keeping the liquid stream 2005 and gas stream 2004 separate until the nozzle discharge hole 2001. The nozzle 2000 includes a circular 5/32″ nozzle discharge hole 2001, and also a welded dispersion tip 2002 with a vertical section 2003. The dispersion tip 2002 contains two separate flow paths, one for the liquid feed 2005 and one for the gas 2004, and both flow paths exit to the vertical section 2003, which exits to the nozzle discharge hole 2001. The nozzle 2000 has a stainless steel inner tubing 2006 (in this example having 0.25 inch OD and 0.179 inch ID) for housing the liquid feed path 2005 and is joined with the dispersion tip 2002 (where the flow continues through a 0.179″ liquid flow path in this example). The inner tubing 2006 also houses the gas flow path 2004, and the gas flow path 2004 is smaller (in this example having a 0.069 inch ID). The smaller cross-sectional area of the gas flow path 2004 is designed to increase the discharge velocity of N₂ gas into the vertical section 2003, where the gas meets the liquid. The higher velocity collision of N₂ gas into the liquid is aimed to induce greater dispersion of liquid into finer droplets upon exit through the nozzle discharge hole 2001. The vertical section 2003 is included to direct the flow towards the center of the reactor tube, away from the walls. The inner tubing 2006 is encased in a stainless steel heat shield 2007.

FIG. 21 illustrates a spray pattern of an exemplary reactor feed nozzle according to FIGS. 20A and 20B. With the circular nozzle discharge hole, the general spray pattern 2101 of the nozzle 2000 approximately resembles a cone. With the vertical section in the dispersion tip, the general spray direction of the nozzle 2000 is perpendicular to the ground. There is also a high degree of liquid dispersion produced by the nozzle 2000, despite the vertical section that acts as a flow-straightener. This liquid dispersion can be attributed to the breaking-up of the liquid phase by collision with the gas phase in the dispersion tip. There is a region of bulk liquid stream (solid line) 2103 and dispersed liquid to the outside of the bulk liquid stream (dotted line) 2102. However, the distinction is minimal, as the bulk liquid stream 2103 also shows substantial liquid dispersion, even near the point of discharge where the density is the greatest.

Different reactor feed nozzles were tested for their influence on the properties of a reactor run and the results of the tests are described herein. The baseline data is provided as a point of reference and not necessarily for direct comparison. Athabasca Bitumen is a very heavy oil produced from the oil sands near Fort McMurray, Alberta, Canada. Belridge is a heavy oil produced near Bakersfield, Calif. EHOS (Exploratory Heavy Oil Sample) is a sample from an exploratory well that was provided for technology demonstration. The EHOS sample was from initial field production and unique to that activity and was from one sampling campaign. The EHOS sample is only representative of the sample itself. UHOS (Unidentified Heavy Oil Sample) is a sample from a heavy oil processing site that was received without designation of source or origin. The UHOS was treated as a blind sample for technology demonstration. API Gravities were measured in accordance with ASTM D70. Viscosities were measured in accordance with ASTM D445. “C7A” represents C7 Asphaltenes in the tables that follow. C7 Asphaltenes were measured in accordance with ASTM D3279. Vanadium and Nickel Content were measured by Inductively Coupled Plasma Mass Spectroscopy (ICP-MS) in accordance with ASTM D5185. Boiling Ranges were calculated based on a High Temperature Simulated Distillation (HTSD) in accordance with ASTM D6352. Boiling ranges in the tables that follow for baseline feed and product were estimated from distillation cut points presented in U.S. Pat. No. 7,572,365. In the tables that follow, “nr” represents a measurement that was not reported.

Table 5 lists feed nozzles that were paired with the same type of lift gas distributor plate for Athabasca Bitumen runs. A representative run was assigned for each configuration, based on the nominal API gravity and liquid weight yield of a particular configuration.

TABLE 5
Feed nozzles used in Athabasca Bitumen runs

| Representative | | Distributor |
|---|---|---|
| Run | Feed Nozzle | Plate |
| A022.A | Nozzle 700 | Distributor I |
| A024.B | Nozzle 1500 | Distributor I |
| A032.A | Nozzle 1700 | Distributor I |
| A034.B | Nozzle 2000 | Distributor I |

In the comparisons presented herein, reference to a baseline run includes data depicted in Table 1 above. Also in the comparisons presented here, Distributor I is representative of a standard prior art lift gas distributor plate. For reference, Distributor I is a circular stainless steel plate having a thickness of ¼ inch and a diameter of 18 inches. A center section of Distributor I has a count of 185 holes with a uniform diameter of 1/17 inches. Each hole is drilled perpendicular (90° angle) to the plate surface, and is laid out in a grid pattern that resembles a regular octagon. All 185 holes, having a total hole area A of 0.502 in², are concentrated within a unit circle having a diameter of 2.58 inches.

With the goal of the reactor system being to convert heavy oil feedstock into light end product, the degree of success for a particular configuration is determined by the measurable properties of the run as well as the product.

The main run property of concern is the liquid weight yield, which is defined as the percentage of feedstock that remains in liquid phase. In a thermal cracking unit, there can be products in the liquid, gas, and solid (coke) phases. The higher the liquid weight yield, the better. The liquid yield is the most valuable result of thermal cracking.

After liquid yield, a product property of concern is the API gravity, which is related to the density of the product, and gives an indication of the “lightness” of the product. The higher the API value, the lighter the product, and thus the more success the thermal cracking process has achieved.

The other product properties of interest are the viscosity, vanadium removal, and nickel removal. The viscosity measures the “thickness” of the product, and is a practical indication of the transportability of the product. In many cases, viscosity reduction is more important than API. Vanadium and nickel are two notable metals that form chemical complexes that are detrimental in refinery processes, and the lower amount contained in the product the better.

Table 6 shows the properties of whole crude used in the baseline run as well as the different Athabasca Bitumen runs. Table 7 shows the properties of product (synthetic crude oil or SCO) used in the baseline run as well as the different Athabasca Bitumen runs. Table 8 summarizes the properties from the baseline run with properties from different Athabasca Bitumen runs.

TABLE 6
Athabasca Bitumen Runs Whole Crude Properties

| | Baseline | Nozzle 700 | Nozzle 1500 | Nozzle 1700 | Nozzle 2000 |
|---|---|---|---|---|---|
| Whole Crude Property | | | | | |
| API Gravity | 8.6 | 8.1 | 8.2 | 7.7 | 7.7 |
| Viscosity @ 40° C., cSt | 40000 | nr | 18199 | 17854 | 17854 |
| Viscosity @ 100° C., cSt | nr | 161 | 201 | 211 | 211 |
| C7 Asphaltenes, wt % | nr | 10.7 | 11.9 | 11.9 | 11.9 |
| Vanadium Content, ppm | 209 | 211 | 223 | 224 | 224 |
| Nickel Content, ppm | 86.0 | 80.6 | 82.3 | 82.3 | 82.3 |
| Boiling Ranges | | | | | |
| <200° F. Content, wt % | 0 | 0 | 0 | 0 | 0 |
| 200-350° F. Content, wt % | 0.0396 | 0.181 | 0.0249 | 0.237 | 0.237 |
| 350-500° F. Content, wt % | 3.60 | 4.88 | 5.91 | 3.51 | 3.51 |
| 500-650° F. Content, wt % | 5.09 | 12.6 | 13.6 | 9.43 | 9.43 |
| 650+° F. Content, wt % | 91.3 | 82.3 | 80.5 | 86.8 | 86.8 |
| 650-850° F. Content, wt % | 20.4 | 24.2 | 24.9 | 17.9 | 17.9 |
| 850-1000° F. Content, wt % | 15.7 | 17.4 | 17.1 | 12.9 | 12.9 |
| 1000+° F. Content, wt % | 55.2 | 40.7 | 38.5 | 56.0 | 56.0 |
| 1000-1200° F. Content, wt % | 20.6 | 19.1 | 20.3 | 16.0 | 16.0 |
| 1200+° F. Content, wt % | 34.6 | 21.6 | 18.2 | 40.0 | 40.0 |

TABLE 7
Athabasca Bitumen Runs Product Properties

| | Baseline | Nozzle 700 | Nozzle 1500 | Nozzle 1700 | Nozzle 2000 |
|---|---|---|---|---|---|
| Synthetic Crude Oil Property | | | | | |
| API Gravity | 12.9 | 13.3 | 17.5 | 12.6 | 12.0 |
| Viscosity @ 40° C., cSt | 201 | nr | 34.7 | 119 | 150 |
| Viscosity @ 100° C., cSt | nr | nr | 4.86 | 11.0 | 11.2 |
| C7 Asphaltenes, wt % | nr | 6.16 | 1.37 | 5.73 | 5.57 |
| Vanadium Content, ppm | 88.0 | 97.9 | 16.5 | 52.6 | 48.6 |
| Nickel Content, ppm | 24.0 | 34.5 | 5.78 | 22.6 | 19.0 |
| Boiling Ranges | | | | | |
| <200° F. Content, wt % | 0.177 | 0 | 0 | 0 | 0 |
| 200-350° F. Content, wt % | 1.92 | 2.84 | 2.07 | 1.33 | 1.82 |
| 350-500° F. Content, wt % | 7.33 | 14.1 | 9.09 | 7.18 | 6.75 |
| 500-650° F. Content, wt % | 8.25 | 23.6 | 25.9 | 19.7 | 18.4 |
| 650+° F. Content, wt % | 82.3 | 59.5 | 62.9 | 71.8 | 73.0 |
| 650-850° F. Content, wt % | 25.7 | 33.1 | 41.0 | 35.7 | 37.3 |
| 850-1000° F. Content, wt % | 19.4 | 13.4 | 16.7 | 20.3 | 21.7 |
| 1000+° F. Content, wt % | 37.2 | 13.0 | 5.24 | 15.8 | 14.0 |
| 1000-1200° F. Content, wt % | 21.3 | 8.34 | 1.22 | 6.62 | 9.96 |
| 1200+° F. Content, wt % | 15.9 | 4.62 | 4.02 | 9.17 | 4.07 |

TABLE 8
Athabasca Bitumen Runs Comparison

| | | | Liquid | Liquid | 1000+ | C7A | | V | Ni |
|---|---|---|---|---|---|---|---|---|---|
| | Run | | Yield, | Yield, | Removal, | Removal, | Viscosity | Removal, | Removal, |
| Nozzle | ID | API | wt % | vol % | wt % | wt % | Reduction, % | wt % | wt % |
| Baseline | nr | 12.9 | 74.4 | nr | 49.9 | nr | 99.5 | 68.7 | 79.2 |
| 700 | A022A | 13.3 | 73.3 | 76.6 | 76.6 | 57.8 | nr | 66.0 | 68.6 |
| 1500 | A024B | 17.5 | 78.6 | 83.9 | 89.3 | 91.0 | 99.8 | 94.2 | 94.5 |
| 1700 | A032A | 12.6 | 85.7 | 89.1 | 75.8 | 58.7 | 99.3 | 79.9 | 76.5 |
| 2000 | A034B | 12.0 | 80.9 | 84.0 | 79.8 | 62.1 | 99.2 | 82.4 | 81.3 |

Table 8 illustrates that all 4 runs show at least one area of improvement over the baseline and nozzle 700. Therefore, nozzles 1500, 1700, and 2000 are all improved feed nozzles.

For the present reactor design, nozzle 700 is the most basic, generic setup. All other nozzles are made to improve on nozzle 700. Therefore, nozzles 1500, 1700, and 2000 are evaluated against nozzle 700.

TABLE 9
Athabasca Bitumen Run Properties Comparison

| | | Nozzle | Nozzle | Nozzle | Nozzle |
|---|---|---|---|---|---|
| Run Property | Baseline | 700 | 1500 | 1700 | 2000 |
| Liquid Volume Yield, | nr | 76.6 | 83.9 | 89.1 | 84.0 |
| vol % | | | | | |
| Liquid Weight Yield, | 74.4 | 73.3 | 78.6 | 85.7 | 80.9 |
| wt % | | | | | |

TABLE 10
Athabasca Bitumen Run Product Properties Comparison

| Synthetic Crude Oil | | Nozzle | Nozzle | Nozzle | Nozzle |
|---|---|---|---|---|---|
| Property | Baseline | 700 | 1500 | 1700 | 2000 |
| API Gravity | 12.9 | 13.3 | 17.5 | 12.6 | 12.0 |
| Viscosity Reduc- | 99.5 | nr | 99.8 | 99.3 | 99.2 |
| tion, % | | | | | |
| C7 Asphaltenes | nr | 57.8 | 91.0 | 58.7 | 62.1 |
| Removal, wt % | | | | | |
| Vanadium Removal, | 68.7 | 66.0 | 94.2 | 79.9 | 82.4 |
| wt % | | | | | |
| Nickel Removal, wt % | 79.2 | 68.6 | 94.5 | 76.5 | 81.3 |
| 1000+° F. Material | 49.9 | 76.6 | 89.3 | 75.8 | 79.8 |
| Removal, wt % | | | | | |

Based on run properties produced by each feed nozzle shown in Table 9, nozzle 1700 demonstrates greater success in liquid retention, while nozzle 1500 and nozzle 2000 have the next highest liquid yields, and are close to each other. Therefore, based on liquid yield performances, nozzle 1500 and nozzle 1700 are the more preferred configurations.

Based on product properties produced by each feed nozzle shown in Table 10, nozzle 1500 demonstrates superior product properties across the board, compared to nozzles 700, 1700, and 2000. Therefore, nozzle 1500 is the most improved feed nozzle based on product properties.

Due to the high value of increased liquid product nozzle 1700 is the most preferred feed nozzle for Athabasca Bitumen runs using Distributor I.

Table 11 lists feed nozzles that were paired with the same type of lift gas distributor plate for Belridge Heavy Oil Sample (BHOS) runs. A representative run was assigned for each configuration, based on the nominal API gravity and liquid weight yield of a particular configuration.

TABLE 11
BHOS Runs Feed Nozzles

| | | Distributor |
|---|---|---|
| Representative run | Feed Nozzle | Plate |
| B031.B | Nozzle 700 | Distributor I |
| B031.A | Nozzle 1300 | Distributor I |

With the goal of the reactor system being to convert heavy oil feedstock into light end products, the degree of success for a particular configuration is determined by the measurable properties of the run as well as the product. Table 12 shows the properties of whole crude used in the baseline as well as the different Belridge Heavy Oil Sample (BHOS) runs. Table 13 shows the properties of product (synthetic crude oil or SCO) used in the baseline run as well as the different Belridge Heavy Oil Sample (BHOS) runs. Table 14 summarizes the properties from the baseline run with properties from different Belridge Heavy Oil Sample (BHOS) runs.

TABLE 12
BHOS Runs Whole Crude Properties

| | | Nozzle | Nozzle |
|---|---|---|---|
| | Baseline | 700 | 1300 |
| Whole Crude Property | | | |
| API Gravity | 8.6 | 13.2 | 13.2 |
| Viscosity @ 40° C., cSt | 40000 | 1155 | 1155 |
| Viscosity @ 100° C., cSt | nr | 31.7 | 31.7 |
| C7 Asphaltenes, wt % | nr | 2.83 | 2.83 |
| Vanadium Content, ppm | 209 | 64.0 | 64.0 |
| Nickel Content, ppm | 86.0 | 51.5 | 51.5 |
| Boiling Ranges | | | |
| <200° F. Content, wt % | 0 | 0.240 | 0.240 |
| 200-350° F. Content, wt % | 0.0396 | 0.180 | 0.180 |
| 350-500° F. Content, wt % | 3.60 | 7.87 | 7.87 |
| 500-650° F. Content, wt % | 5.09 | 14.7 | 14.7 |
| 650+° F. Content, wt % | 91.3 | 77.0 | 77.0 |
| 650-850° F. Content, wt % | 20.4 | 25.6 | 25.6 |
| 850-1000° F. Content, wt % | 15.7 | 19.2 | 19.2 |
| 1000+° F. Content, wt % | 55.2 | 32.2 | 32.2 |
| 1000-1200° F. Content, wt % | 20.6 | 12.8 | 12.8 |
| 1200+° F. Content, wt % | 34.6 | 19.4 | 19.4 |

TABLE 13
BHOS Runs Product Properties

| | | Nozzle | Nozzle |
|---|---|---|---|
| | Baseline | 700 | 1300 |
| Synthetic Crude Oil Property | | | |
| API Gravity | 12.9 | 15.5 | 14.5 |
| Viscosity @ 40° C., cSt | 201 | 62.8 | 143 |
| Viscosity @ 100° C., cSt | nr | 9.11 | 12.7 |
| C7 Asphaltenes, wt % | nr | 4.10 | 3.94 |
| Vanadium Content, ppm | 88.0 | 25.6 | 45.3 |
| Nickel Content, ppm | 24.0 | 22.1 | 40.4 |
| Boiling Ranges | | | |
| <200° F. Content, wt % | 0.177 | 0 | 0 |
| 200-350° F. Content, wt % | 1.92 | 1.64 | 0 |
| 350-500° F. Content, wt % | 7.33 | 10.9 | 9.66 |
| 500-650° F. Content, wt % | 8.25 | 23.2 | 21.2 |
| 650+° F. Content, wt % | 82.3 | 64.3 | 69.1 |
| 650-850° F. Content, wt % | 25.7 | 34.2 | 35.7 |
| 850-1000° F. Content, wt % | 19.4 | 15.4 | 17.6 |
| 1000+° F. Content, wt % | 37.2 | 14.7 | 15.8 |
| 1000-1200° F. Content, wt % | 21.3 | 4.01 | 7.43 |
| 1200+° F. Content, wt % | 15.9 | 10.7 | 8.41 |

TABLE 14
BHOS Runs Comparison

| | | | Liquid | Liquid | 1000+ | C7A | | V | Ni |
|---|---|---|---|---|---|---|---|---|---|
| | Run | | Yield, | Yield, | Removal, | Removal, | Viscosity | Removal, | Removal, |
| Nozzle | ID | API | wt % | vol % | wt % | wt % | Reduction, % | wt % | wt % |
| Baseline | Nr | 12.9 | 74.4 | nr | 49.9 | nr | 99.5 | 68.7 | 79.2 |
| 700 | B031B | 15.5 | 77.5 | 80.3 | 64.6 | nr | 94.6 | 69.0 | 66.7 |
| 1300 | B031A | 14.5 | 81.1 | 83.6 | 60.2 | nr | 87.6 | 42.6 | 36.4 |

Table 14 illustrates that both runs show at least one area of improvement over the baseline. Therefore, nozzles 700 and 1300 are both improved feed nozzles.

For the present reactor design, nozzle 700 represents standard, prior design. All other nozzles are made to improve on nozzle 700. Therefore, nozzle 1300 is evaluated against nozzle 700.

TABLE 15
BHOS Run Properties Comparison

| | | Nozzle | Nozzle |
|---|---|---|---|
| Run Property | Baseline | 700 | 1300 |
| Liquid Volume Yield, vol % | nr | 80.3 | 83.6 |
| Liquid Weight Yield, wt % | 74.4 | 77.5 | 81.1 |

TABLE 16
BHOS Product Properties Comparison

| | | Nozzle | Nozzle |
|---|---|---|---|
| Synthetic Crude Oil Property | Baseline | 700 | 1300 |
| API Gravity | 12.9 | 15.5 | 14.5 |
| Viscosity Reduction, % | 99.5 | 94.6 | 87.6 |
| C7 Asphaltenes Removal, wt % | nr | nr | nr |
| Vanadium Removal, wt % | 68.7 | 69.0 | 42.6 |
| Nickel Removal, wt % | 79.2 | 66.7 | 36.4 |
| 1000° F.+ Material Removal, wt % | 49.9 | 64.6 | 60.2 |

Based on run properties produced by each feed nozzle shown in Table 15, nozzle 1300 has higher liquid yield. Therefore, based on run properties, nozzle 1300 is the more preferred configuration than nozzle 700.

Table 17 lists feed nozzles that were paired with the same type of lift gas distributor plate for Unidentified Heavy Oil Sample (UHOS) runs. A representative run was assigned for each configuration, based on the nominal API gravity and liquid weight yield of a particular configuration.

TABLE 17
Nozzle-distributor combinations of UHOS runs

| | | Distributor |
|---|---|---|
| Representative run | Feed Nozzle | Plate |
| U036.B | Nozzle 700 | Distributor I |
| U037.A | Nozzle 2000 | Distributor I |

With the goal of the reactor system being to convert heavy oil feedstock into light end products, the degree of success for a particular configuration is determined by the measurable properties of the run as well as the product. Table 18 shows the properties of whole crude used in the baseline as well as the different Unidentified Heavy Oil Sample (UHOS) runs. Table 19 shows the properties of product (synthetic crude oil or SCO) used in the baseline run as well as the different Unidentified Heavy Oil Sample (UHOS) runs. Table 20 summarizes the properties from the baseline run with properties from different Unidentified Heavy Oil Sample (UHOS) runs.

TABLE 18
UHOS Runs Whole Crude Properties

| | | Nozzle | Nozzle |
|---|---|---|---|
| | Baseline | 700 | 2000 |
| Whole Crude Property | | | |
| API Gravity | 8.6 | 10.8 | 10.8 |
| Viscosity @ 40° C., cSt | 40000 | 4725 | 4725 |
| Viscosity @ 100° C., cSt | nr | 147 | 147 |
| C7 Asphaltenes, wt % | nr | 17.3 | 17.3 |
| Vanadium Content, ppm | 209 | 450 | 450 |
| Nickel Content, ppm | 86.0 | 83.3 | 83.3 |
| Boiling Ranges | | | |
| <200° F. Content, wt % | 0 | 0.302 | 0.302 |
| 200-350° F. Content, wt % | 0.0396 | 3.39 | 3.39 |
| 350-500° F. Content, wt % | 3.60 | 5.70 | 5.70 |
| 500-650° F. Content, wt % | 5.09 | 9.29 | 9.29 |
| 650+° F. Content, wt % | 91.3 | 81.3 | 81.3 |
| 650-850° F. Content, wt % | 20.4 | 13.4 | 13.4 |
| 850-1000° F. Content, wt % | 15.7 | 13.7 | 13.7 |
| 1000+° F. Content, wt % | 55.2 | 54.2 | 54.2 |
| 1000-1200° F. Content, wt % | 20.6 | 17.7 | 17.7 |
| 1200+° F. Content, wt % | 34.6 | 36.5 | 36.5 |

TABLE 19
UHOS Runs Product Properties

| | | Nozzle | Nozzle |
|---|---|---|---|
| | Baseline | 700 | 2000 |
| Synthetic Crude Oil Property | | | |
| API Gravity | 12.9 | 17.9 | 16.7 |
| Viscosity @ 40° C., cSt | 201 | 39.1 | 68.4 |
| Viscosity @ 100° C., cSt | nr | 12.3 | 7.27 |
| C7 Asphaltenes, wt % | nr | 4.82 | 6.87 |
| Vanadium Content, ppm | 88.0 | 105 | 170 |
| Nickel Content, ppm | 24.0 | 19.2 | 29.6 |
| Boiling Ranges | | | |
| <200° F. Content, wt % | 0.177 | 0 | 0 |
| 200-350° F. Content, wt % | 1.92 | 5.77 | 5.16 |
| 350-500° F. Content, wt % | 7.33 | 11.2 | 10.4 |
| 500-650° F. Content, wt % | 8.25 | 18.5 | 17.4 |
| 650+° F. Content, wt % | 82.3 | 64.5 | 67.0 |
| 650-850° F. Content, wt % | 25.7 | 27.9 | 25.1 |
| 850-1000° F. Content, wt % | 19.4 | 17.2 | 15.7 |
| 1000+° F. Content, wt % | 37.2 | 19.4 | 26.2 |
| 1000-1200° F. Content, wt % | 21.3 | 7.27 | 9.70 |
| 1200+° F. Content, wt % | 15.9 | 12.2 | 16.5 |

TABLE 20
UHOS Run Comparison

| | | | Liquid | Liquid | 1000+ | C7A | | V | Ni |
|---|---|---|---|---|---|---|---|---|---|
| | Run | | Yield, | Yield, | Removal, | Removal, | Viscosity | Removal, | Removal, |
| Nozzle | ID | API | wt % | vol % | wt % | wt % | Reduction, % | wt % | wt % |
| Baseline | Nr | 12.9 | 74.4 | nr | 49.9 | nr | 99.5 | 68.7 | 79.2 |
| 700 | U036B | 17.9 | 80.2 | 83.5 | 71.3 | 77.7 | 99.2 | 81.3 | 81.5 |
| 2000 | U037A | 16.7 | 82.0 | 84.6 | 60.4 | 67.4 | 98.6 | 69.0 | 70.9 |

Table 20 illustrates that both runs show at least one area of improvement over the standard design baseline. Therefore, nozzles 700 and 2000 are both preferred feed nozzles.

For the present reactor design, nozzle 700 represents standard, prior design. All other nozzles are made to improve on nozzle 700. Therefore, nozzle 2000 is evaluated against nozzle 700.

TABLE 21
UHOS Run Properties Comparison

| | | Nozzle | Nozzle |
|---|---|---|---|
| Run Property | Baseline | 700 | 2000 |
| Liquid Volume Yield, vol % | nr | 83.5 | 84.6 |
| Liquid Weight Yield, wt % | 74.4 | 80.2 | 82.0 |

TABLE 22
UHOS Product Properties Comparison

| | | Nozzle | Nozzle |
|---|---|---|---|
| Synthetic Crude Oil Property | Baseline | 700 | 2000 |
| API Gravity | 12.9 | 17.9 | 16.7 |
| Viscosity Reduction, % | 99.5 | 99.2 | 98.6 |
| C7 Asphaltenes Removal, wt % | nr | 77.7 | 67.4 |
| Vanadium Removal, wt % | 68.7 | 81.3 | 69.0 |
| Nickel Removal, wt % | 79.2 | 81.5 | 70.9 |
| 1000° F.+ Material Removal, wt % | 49.9 | 71.3 | 60.4 |

Based on run properties produced by each feed nozzle shown in Table 21, nozzle 2000 demonstrates greater success in liquid retention. Therefore, based on liquid yield, nozzle 2000 is the more preferred feed nozzle over nozzle 700.

Different configurations of reactor feed nozzle and lift gas distributor plates were tested. A complete discussion of each lift gas distributor plate referred to herein can be found in U.S. patent application Ser. No. ______ which is hereby incorporated by reference in its entirety for all purposes. Table 23 summarizes a numbered selection of the feed nozzle and distributor plate combinations used in Athabasca Bitumen Runs. A representative run was assigned for each configuration, based on the nominal API gravity and liquid weight yield of a particular configuration.

TABLE 23
Athabasca Bitumen Run Nozzle-Distributor Combinations

| | Representative | | |
|---|---|---|---|
| Configuration # | Run | Feed Nozzle | Distributor Plate |
| 1 | A022.A | Nozzle 700 | Distributor 400 |
| 2 | A013.A | Nozzle 1300 | Distributor 800 |
| 3 | A024.B | Nozzle 1500 | Distributor 400 |
| 4 | A032.A | Nozzle 1700 | Distributor 400 |
| 5 | A034.B | Nozzle 2000 | Distributor 400 |

Table 24 shows the properties of whole crude used in the baseline as well as the different Athabasca Bitumen run configurations. Table 25 shows the properties of product (SCO or synthetic crude oil) used in the different Athabasca Bitumen run configurations. Table 26 summarizes the properties from different Athabasca Bitumen run configurations.

TABLE 24
Athabasca Bitumen Runs Whole Crude Properties

| Whole Crude Property | Baseline | 1 | 2 | 3 | 4 | 5 |
|---|---|---|---|---|---|---|
| API Gravity | 8.6 | 8.1 | 8.9 | 8.2 | 7.7 | 7.7 |
| Viscosity @ 40° C., cSt | 40000 | Nr | nr | 18199 | 17854 | 17854 |
| Viscosity @ 100° C., cSt | nr | 161 | 179 | 201 | 211 | 211 |
| C7 Asphaltenes, wt % | nr | 10.7 | 15.7 | 11.9 | 11.9 | 11.9 |
| Vanadium Content, ppm | 209 | 211 | 214 | 223 | 224 | 224 |
| Nickel Content, ppm | 86.0 | 80.6 | 83.4 | 82.3 | 82.3 | 82.3 |
| Boiling Ranges | | | | | | |
| <200° F. Content, wt % | 0 | 0 | 0 | 0 | 0 | 0 |
| 200-350° F. Content, wt % | 0.0396 | 0.181 | 0 | 0.0249 | 0.237 | 0.237 |
| 350-500° F. Content, wt % | 3.60 | 4.88 | 4.97 | 5.91 | 3.51 | 3.51 |
| 500-650° F. Content, wt % | 5.09 | 12.6 | 11.6 | 13.6 | 9.43 | 9.43 |
| 650+ ° F. Content, wt % | 91.3 | 82.3 | 83.4 | 80.5 | 86.8 | 86.8 |
| 650-850° F. Content, wt % | 20.4 | 24.2 | 21.3 | 24.9 | 17.9 | 17.9 |
| 850-1000° F. Content, wt % | 15.7 | 17.4 | 14.8 | 17.1 | 12.9 | 12.9 |
| 1000+ ° F. Content, wt % | 55.2 | 40.7 | 47.4 | 38.5 | 56.0 | 56.0 |

TABLE 25
Athabasca Bitumen Runs Product Properties

| SCO Property | Baseline | 1 | 2 | 3 | 4 | 5 |
|---|---|---|---|---|---|---|
| API Gravity | 12.9 | 13.3 | 18.1 | 17.5 | 12.6 | 12 |
| Viscosity @ 40° C., | 201 | nr | Nr | 34.7 | 119 | 150 |
| cSt | | | | | | |
| Viscosity @ | Nr | nr | 4.86 | 4.86 | 11.0 | 11.2 |
| 100° C., cSt | | | | | | |
| C7 Asphaltenes, | Nr | 6.16 | 6.19 | 1.37 | 5.73 | 5.57 |
| wt % | | | | | | |
| Vanadium Content, | 88.0 | 97.9 | 20.1 | 16.5 | 52.6 | 48.6 |
| ppm | | | | | | |
| Nickel Content, | 24.0 | 34.5 | 10.9 | 5.78 | 22.6 | 19.0 |
| ppm | | | | | | |
| Boiling Ranges | | | | | | |
| <200° F. Content, | 0.177 | 0 | 0 | 0 | 0 | 0 |
| wt % | | | | | | |
| 200-350° F. | 1.92 | 2.84 | 1.16 | 2.07 | 1.33 | 1.82 |
| Content, wt % | | | | | | |
| 350-500° F. | 7.33 | 14.1 | 6.92 | 9.09 | 7.18 | 6.75 |
| Content, wt % | | | | | | |
| 500-650° F. | 8.25 | 23.6 | 21.1 | 25.9 | 19.7 | 18.4 |
| Content, wt % | | | | | | |
| 650+ ° F. Content, | 82.3 | 59.5 | 70.8 | 62.9 | 71.8 | 73.0 |
| wt % | | | | | | |
| 650-850° F. | 25.7 | 33.1 | 50.7 | 41.0 | 35.7 | 37.3 |
| Content, wt % | | | | | | |
| 850-1000° F. | 19.4 | 13.4 | 13.3 | 16.7 | 20.3 | 21.7 |
| Content, wt % | | | | | | |
| 1000+ ° F. Content, | 37.2 | 13.0 | 6.82 | 5.24 | 15.8 | 14.0 |
| wt % | | | | | | |

TABLE 26
Athabasca Bitumen Run Comparison

| | | | Liquid | Liquid | 1000+ | C7A | | V | Ni |
|---|---|---|---|---|---|---|---|---|---|
| | Run | | Yield, | Yield, | Removal, | Removal, | Viscosity | Removal, | Removal, |
| Configuration | ID | API | wt % | vol % | wt % | wt % | Reduction, % | wt % | wt % |
| Baseline | nr | 12.9 | 74.4 | nr | 49.9 | nr | 99.5 | 68.7 | 79.2 |
| 1 | A022A | 13.3 | 73.3 | 76.6 | 76.6 | 57.8 | nr | 66.0 | 68.6 |
| 2 | A013A | 18.1 | 95.5 | 104 | 86.2 | 62.3 | 97.3 | 91.0 | 87.5 |
| 3 | A024B | 17.5 | 78.6 | 83.9 | 89.3 | 91.0 | 99.8 | 94.2 | 94.5 |
| 4 | A032A | 12.6 | 85.7 | 89.1 | 75.8 | 58.7 | 99.3 | 79.9 | 76.5 |
| 5 | A034B | 12.0 | 80.9 | 84.0 | 79.8 | 62.1 | 99.2 | 82.4 | 81.3 |

As shown in Table 26, all 5 configurations show at least one area of improvement over the baseline. Therefore, configurations 1, 2, 3, 4, and 5 are all preferred configurations.

TABLE 27
Whole Crude Basis Run Properties Comparison

| Run Property | Baseline | 1 | 2 | 3 | 4 | 5 |
|---|---|---|---|---|---|---|
| Liquid Volume Yield, | Nr | 76.6 | 104 | 83.9 | 89.1 | 84.0 |
| vol % | | | | | | |
| Liquid Weight Yield, | 74.4 | 73.3 | 95.5 | 78.6 | 85.7 | 80.9 |
| wt % | | | | | | |

TABLE 28
Product Properties Comparison

| SCO Property | Baseline | 1 | 2 | 3 | 4 | 5 |
|---|---|---|---|---|---|---|
| API Gravity | 12.9 | 13.3 | 18.1 | 17.5 | 12.6 | 12.0 |
| Viscosity Reduction, % | 99.5 | nr | 97.3 | 99.8 | 99.3 | 99.2 |
| C7 Asphaltenes | nr | 57.8 | 62.3 | 91.0 | 58.7 | 62.1 |
| Removal, wt % | | | | | | |
| Vanadium Removal, | 68.7 | 66.0 | 91.0 | 94.2 | 79.9 | 82.4 |
| wt % | | | | | | |
| Nickel Removal, wt % | 79.2 | 68.6 | 87.5 | 94.5 | 76.5 | 81.3 |
| 1000+ ° F. Material | 49.9 | 76.6 | 86.2 | 89.3 | 75.8 | 79.8 |
| Removal, wt % | | | | | | |

Based on run properties of each configuration shown in Table 27, configuration 2 demonstrates greater success in liquid retention. The yield figures suggest that configurations 2, 3, 4, and 5 all have superior liquid yield. Configuration 2 is clearly superior to the other configurations due to higher liquid yield.

Based on product properties of each configuration shown in Table 28, configurations 2 and 3 demonstrate better product properties across the board, compared to all 5 configurations. In terms of API, viscosity reduction, removal of heavy fraction, asphaltenes removal, and metals removal, configurations 2 and 3 show the most significant improvement in most or all areas.

Combining the assessment of both liquid yield and product properties, only configuration 2 demonstrates superior performance in both areas. Therefore, configuration 2 (Nozzle 1300+Distributor 800 combination) is the most preferred configuration, for Athabasca Runs.

Table 29 summarizes numbered feed nozzle and distributor plate combinations used in Belridge Heavy Oil Sample (BHOS) Runs. A representative run was assigned for each configuration, based on the nominal API gravity and liquid weight yield of a particular configuration.

TABLE 29
BHOS Runs Nozzle-Distributor Combinations

| Configuration | Representative Run | Feed Nozzle | Distributor Plate |
|---|---|---|---|
| 6 | B031.B | Nozzle 700 | Distributor 400 |
| 7 | B011.A | Nozzle 700 | Distributor 800 |
| 8 | B031.A | Nozzle 1300 | Distributor 400 |

Table 30 shows the properties of whole crude used in the baseline as well as the different BHOS run configurations. Table 31 shows the properties of product (SCO or synthetic crude oil) used in the different BHOS run configurations. Table 32 summarizes the properties from different BHOS Run configurations.

TABLE 30
BHOS Runs Whole Crude Properties

| | Baseline | 6 | 7 | 8 |
|---|---|---|---|---|
| Whole Crude Property | | | | |
| API Gravity | 8.6 | 13.2 | 13.2 | 13.2 |
| Viscosity @ 40° C., | 40000 | 1155 | 1155 | 1155 |
| cSt | | | | |
| Viscosity @ 100° C., | nr | 31.7 | 31.7 | 31.7 |
| cSt | | | | |
| C7 Asphaltenes, wt % | nr | 2.83 | 2.83 | 2.83 |
| Vanadium Content, | 209 | 64.0 | 64.0 | 64.0 |
| ppm | | | | |
| Nickel Content, ppm | 86.0 | 51.5 | 51.5 | 51.5 |
| Boiling Ranges | | | | |
| <200° F. Content, | 0 | 0.240 | 0.240 | 0.240 |
| wt % | | | | |
| 200-350° F. Content, | 0.0396 | 0.180 | 0.180 | 0.180 |
| wt % | | | | |
| 350-500° F. Content, | 3.60 | 7.87 | 7.87 | 7.87 |
| wt % | | | | |
| 500-650° F. Content, | 5.09 | 14.7 | 14.7 | 14.7 |
| wt % | | | | |
| 650+° F. Content, | 91.3 | 77.0 | 77.0 | 77.0 |
| wt % | | | | |
| 650-850° F. Content, | 20.4 | 25.6 | 25.6 | 25.6 |
| wt % | | | | |
| 850-1000° F. Content, | 15.7 | 19.2 | 19.2 | 19.2 |
| wt % | | | | |
| 1000+° F. Content, | 55.2 | 32.2 | 32.2 | 32.2 |
| wt % | | | | |
| 1000-1200° F. Con- | 20.6 | 12.8 | 12.8 | 12.8 |
| tent, wt % | | | | |
| 1200+° F. Content, | 34.6 | 19.4 | 19.4 | 19.4 |
| wt % | | | | |

TABLE 31
BHOS Runs Product Properties

| | Baseline | 6 | 7 | 8 |
|---|---|---|---|---|
| SCO Property | | | | |
| API Gravity | 12.9 | 15.5 | 16.9 | 14.5 |
| Viscosity @ 40° C., | 201 | 62.8 | 63.6 | 143 |
| cSt | | | | |
| Viscosity @ 100° C., | nr | 9.11 | 6.45 | 12.7 |
| cSt | | | | |
| C7 Asphaltenes, wt % | nr | nr | 1.27 | nr |
| Vanadium Content, | 88.0 | 25.6 | 27.7 | 45.3 |
| ppm | | | | |
| Nickel Content, ppm | 24.0 | 22.1 | 26.1 | 40.4 |
| Boiling Ranges | | | | |
| <200° F. Content, | 0.177 | 0 | 0 | 0 |
| wt % | | | | |
| 200-350° F. Content, | 1.92 | 1.64 | 2.85 | 0 |
| wt % | | | | |
| 350-500° F. Content, | 7.33 | 10.9 | 9.74 | 9.66 |
| wt % | | | | |
| 500-650° F. Content, | 8.25 | 23.2 | 21.2 | 21.2 |
| wt % | | | | |
| 650+° F. Content, | 82.3 | 64.3 | 66.2 | 69.1 |
| wt % | | | | |
| 650-850° F. Content, | 25.7 | 34.2 | 42.6 | 35.7 |
| wt % | | | | |
| 850-1000° F. Content, | 19.4 | 15.4 | 16.7 | 17.6 |
| wt % | | | | |
| 1000+° F. Content, | 37.2 | 14.7 | 6.91 | 15.8 |
| wt % | | | | |
| 1000-1200° F. Con- | 21.3 | 4.01 | 6.28 | 7.43 |
| tent, wt % | | | | |
| 1200+° F. Content, | 15.9 | 10.7 | 0.630 | 8.41 |
| wt % | | | | |

TABLE 32
BHOS Run Comparison

| | | | Liquid | Liquid | 1000+ | C7A | | V | Ni |
|---|---|---|---|---|---|---|---|---|---|
| | Run | | Yield, | Yield, | Removal, | Removal, | Viscosity | Removal, | Removal, |
| Configuration | ID | API | wt % | vol % | wt % | wt % | Reduction, % | wt % | wt % |
| Baseline | nr | 12.9 | 74.4 | nr | 49.9 | nr | 99.5 | 68.7 | 79.2 |
| 6 | B031B | 15.5 | 77.5 | 80.3 | 64.6 | nr | 94.6 | 69.0 | 66.7 |
| 7 | B011A | 16.9 | 82.5 | 84.9 | 82.3 | 63.0 | 94.5 | 64.3 | 58.2 |
| 8 | B031A | 14.5 | 81.1 | 83.6 | 60.2 | nr | 87.6 | 42.6 | 36.4 |

Table 33 compares the run properties of the BHOS run configurations. Table 34 compares the product properties of the BHOS run configurations.

TABLE 33
BHOS Whole Crude Basis Run Properties Comparison

| Run Property | Baseline | 6 | 7 | 8 |
|---|---|---|---|---|
| Liquid Volume Yield, vol % | nr | 80.3 | 84.9 | 83.6 |
| Liquid Weight Yield, wt % | 74.4 | 77.5 | 82.5 | 81.1 |

TABLE 34
BHOS Product Properties Comparison

| Synthetic Crude Oil Property | Baseline | 6 | 7 | 8 |
|---|---|---|---|---|
| API Gravity | 12.9 | 15.5 | 16.9 | 14.5 |
| Viscosity Reduction, % | 99.5 | 94.6 | 94.5 | 87.6 |
| C7 Asphaltenes Removal, wt % | nr | nr | 63.0 | nr |
| Vanadium Removal, wt % | 68.7 | 69.0 | 64.3 | 42.6 |
| Nickel Removal, wt % | 79.2 | 66.7 | 58.2 | 36.4 |
| 1000° F.+ Material Removal, wt % | 49.9 | 64.6 | 82.3 | 60.2 |

Based on Run properties of each configuration shown in Table 33, configuration 7 demonstrates the greatest success in liquid retention. The yield figures suggest that configuration 7 have better liquid yield than configurations 6 and 8. Therefore, based on run properties, configuration 8 is the more preferred configuration, followed by configuration 7.

Based on product properties of each configuration shown in Table 34, configuration 7 demonstrates superior product properties in areas of API and asphaltenes removal. Configuration 6, in the other hand, is superior in viscosity reduction, metal removal, and removal of heavy fraction.

Combining the assessment of both run and product properties, only configuration 7 demonstrates good performance in both areas. Therefore, configuration 7 (Nozzle 700+Distributor 800 combination) is the most preferred configuration, for BHOS Runs.

Table 35 lists and numbers the feed nozzle and distributor plate combinations used in Exploratory Heavy Oil Sample (EHOS) Runs. A representative run was assigned for each configuration, based on the nominal API gravity and liquid weight yield of a particular configuration.

TABLE 35
EHOS Runs Nozzle-Distributor Combinations

| Configuration | Representative Run | Feed Nozzle | Distributor Plate |
|---|---|---|---|
| 9 | E045.B | Nozzle 700 | Distributor 700 |
| 10 | E044.A | Nozzle 700 | Distributor 1100 |
| 11 | E043.B | Nozzle 2000 | Distributor 1100 |

Table 36 shows the properties of whole crude used in the baseline as well as the different EHOS run configurations. Table 37 shows the properties of product (SCO or synthetic crude oil) used in the different EHOS run configurations. Table 38 summarizes the properties from different EHOS run configurations.

TABLE 36
EHOS Runs Whole Crude Properties

| | Baseline | 9 | 10 | 11 |
|---|---|---|---|---|
| Whole Crude Property | | | | |
| API Gravity | 8.6 | 7.7 | 8.4 | 8.4 |
| Viscosity @ 40° C., | 40000 | nr | Nr | nr |
| cSt | | | | |
| Viscosity @ 100° C., | nr | 657 | 591 | 587 |
| cSt | | | | |
| C7 Asphaltenes, wt % | nr | 13.8 | 14.3 | 13.6 |
| Vanadium Content, | 209 | 458 | 452 | 473 |
| ppm | | | | |
| Nickel Content, ppm | 86.0 | 151 | 141 | 147 |
| Boiling Ranges | | | | |
| <200° F. Content, | 0 | 0 | 0 | 0 |
| wt % | | | | |
| 200-350° F. Content, | 0.0396 | 0 | 0 | 0 |
| wt % | | | | |
| 350-500° F. Content, | 3.60 | 1.88 | 2.00 | 2.44 |
| wt % | | | | |
| 500-650° F. Content, | 5.09 | 9.22 | 9.23 | 8.88 |
| wt % | | | | |
| 650+° F. Content, | 91.3 | 88.9 | 88.8 | 88.7 |
| wt % | | | | |
| 650-850° F. Content, | 20.4 | 17.6 | 17.3 | 15.5 |
| wt % | | | | |
| 850-1000° F. Content, | 15.7 | 13.6 | 13.3 | 12.4 |
| wt % | | | | |
| 1000+° F. Content, | 55.2 | 57.7 | 58.2 | 60.8 |
| wt % | | | | |
| 1000-1200° F. Con- | 20.6 | 18.3 | 18.1 | 17.9 |
| tent, wt % | | | | |
| 1200+° F. Content, | 34.6 | 39.4 | 40.0 | 42.9 |
| wt % | | | | |

TABLE 37
EHOS Runs Product Properties

| | Baseline | 9 | 10 | 11 |
|---|---|---|---|---|
| Synthetic Crude Oil Property | | | | |
| API Gravity | 12.9 | 14.8 | 16.4 | 16.1 |
| Viscosity @ 40° C., | 201 | 33.5 | 39.6 | 36.0 |
| cSt | | | | |
| Viscosity @ 100° C., | nr | 6.80 | 5.25 | 6.45 |
| cSt | | | | |
| C7 Asphaltenes, wt % | nr | 5.23 | 4.12 | 4.19 |
| Vanadium Content, | 88.0 | 79.2 | 119 | 121 |
| ppm | | | | |
| Nickel Content, ppm | 24.0 | 25.1 | 38.1 | 37.7 |
| Boiling Ranges | | | | |
| <200° F. Content, | 0.177 | 0 | 0 | 0 |
| wt % | | | | |
| 200-350° F. Content, | 1.92 | 4.18 | 3.06 | 3.83 |
| wt % | | | | |
| 350-500° F. Content, | 7.33 | 12.9 | 12.8 | 11.5 |
| wt % | | | | |
| 500-650° F. Content, | 8.25 | 23.7 | 19.5 | 16.9 |
| wt % | | | | |
| 650+° F. Content, | 82.3 | 59.2 | 64.6 | 67.8 |
| wt % | | | | |
| 650-850° F. Content, | 25.7 | 36.6 | 35.0 | 31.2 |
| wt % | | | | |
| 850-1000° F. Content, | 19.4 | 15.0 | 13.5 | 15.5 |
| wt % | | | | |
| 1000+° F. Content, | 37.2 | 7.62 | 16.1 | 21.1 |
| wt % | | | | |
| 1000-1200° F. Con- | 21.3 | 4.11 | 6.12 | 7.98 |
| tent, wt % | | | | |
| 1200+° F. Content, | 15.9 | 3.51 | 10.0 | 13.1 |
| wt % | | | | |

TABLE 38
EHOS Run Comparison

| | | | Liquid | Liquid | 1000+ | C7A | | V | Ni |
|---|---|---|---|---|---|---|---|---|---|
| | | | Yield, | Yield, | Removal, | Removal, | Viscosity | Removal, | Removal, |
| Configuration | Run ID | API | wt % | vol % | wt % | wt % | Reduction, % | wt % | wt % |
| Baseline | nr | 12.9 | 74.4 | nr | 49.9 | nr | 99.5 | 68.7 | 79.2 |
| 9 | E045B | 14.8 | 62.7 | 67.5 | 91.7 | 76.2 | 99.0 | 89.2 | 89.6 |
| 10 | E044A | 16.4 | 90.1 | 96.1 | 75.1 | 74.0 | 99.1 | 76.3 | 75.7 |
| 11 | E043B | 16.1 | 78.3 | 83.6 | 72.8 | 75.9 | 98.9 | 80.0 | 79.9 |

Table 39 compares the run properties of the EHOS run configurations. Table compares the product properties of the EHOS run configurations.

TABLE 39
EHOS Whole Crude Basis Run Properties Comparison

| Run Property | Baseline | 9 | 10 | 11 |
|---|---|---|---|---|
| Liquid Volume Yield, vol % | Nr | 67.5 | 96.1 | 83.6 |
| Liquid Weight Yield, wt % | 74.4 | 62.7 | 90.1 | 78.3 |

TABLE 40
EHOS Product Properties Comparison

| Synthetic Crude Oil Property | Baseline | 9 | 10 | 11 |
|---|---|---|---|---|
| API Gravity | 12.9 | 14.8 | 16.4 | 16.1 |
| Viscosity Reduction, % | 99.5 | nr | Nr | nr |
| C7 Asphaltenes Removal, wt % | nr | 76.2 | 74.0 | 75.9 |
| Vanadium Removal, wt % | 68.7 | 89.2 | 76.3 | 80.0 |
| Nickel Removal, wt % | 79.2 | 89.6 | 75.7 | 79.9 |
| 1000° F.+ Material Removal, wt % | 49.9 | 91.7 | 75.1 | 72.8 |

Based on run properties of each configuration shown in Table 39, configuration 10 demonstrates the greatest success in liquid retention. The yield figures suggest that configuration 10 has much better liquid yield than configurations 9 and 11. Therefore, configuration 10 is the more preferred configuration.

Based on product properties of each configuration shown in Table 40, configurations 9 and 10 both demonstrate superior product properties across the board. While configuration 9 has the best viscosity reduction, heavy material removal, and metal removal, configuration 10 has the best API and asphaltenes removal. For the areas where configuration 10 is not the best, it is still comparably close to the other 2 configurations.

Combining the assessment of both run and product properties, only configuration 10 demonstrates good performance in both areas. Therefore, configuration 10 (Nozzle 700+Distributor 1100 combination) is the most preferred configuration, for EHOS runs.

Table 41 lists and numbers the feed nozzle and distributor plate combinations used in Unidentified Heavy Oil Sample (UHOS) runs. A representative run was assigned for each configuration, based on the nominal API gravity and liquid weight yield of a particular configuration.

TABLE 41
UHOS Nozzle-Distributor Combinations

| Configuration # | Representative Run | Feed Nozzle | Distributor Plate |
|---|---|---|---|
| 13 | U038.A | Nozzle 700 | Distributor 1100 |
| 14 | U037.B | Nozzle 700 | Distributor 1200 |
| 15 | U037.A | Nozzle 2000 | Distributor 400 |

Table 42 shows the properties of whole crude used in the baseline as well as the different UHOS run configurations. Table 43 shows the properties of product (SCO or synthetic crude oil) used the different UHOS run configurations. Table 44 summarizes the properties from different UHOS run configurations.

TABLE 42
UHOS Runs Whole Crude Properties

| | Baseline | 13 | 14 | 15 |
|---|---|---|---|---|
| Whole Crude Property | | | | |
| API Gravity | 8.6 | 11.3 | 10.8 | 10.8 |
| Viscosity @ 40° C., | 40000 | 5717 | 4725 | 4725 |
| cSt | | | | |
| Viscosity @ 100° C., | nr | 143 | 147 | 147 |
| cSt | | | | |
| C7 Asphaltenes, wt % | nr | 16.9 | 17.3 | 17.3 |
| Vanadium Content, | 209 | 435 | 450 | 450 |
| ppm | | | | |
| Nickel Content, ppm | 86.0 | 81.1 | 83.3 | 83.3 |
| Boiling Ranges | | | | |
| <200° F. Content, | 0 | 0.237 | 0.302 | 0.302 |
| wt % | | | | |
| 200-350° F. Content, | 0.0396 | 4.27 | 3.39 | 3.39 |
| wt % | | | | |
| 350-500° F. Content, | 3.60 | 6.19 | 5.70 | 5.70 |
| wt % | | | | |
| 500-650° F. Content, | 5.09 | 8.40 | 9.29 | 9.29 |
| wt % | | | | |
| 650+° F. Content, | 91.3 | 80.9 | 81.3 | 81.3 |
| wt % | | | | |
| 650-850° F. Content, | 20.4 | 13.0 | 13.4 | 13.4 |
| wt % | | | | |
| 850-1000° F. Content, | 15.7 | 10.2 | 13.7 | 13.7 |
| wt % | | | | |
| 1000+° F. Content, | 55.2 | 57.7 | 54.2 | 54.2 |
| wt % | | | | |
| 1000-1200° F. Con- | 20.6 | 17.4 | 17.7 | 17.7 |
| tent, wt % | | | | |
| 1200+° F. Content, | 34.6 | 40.3 | 36.5 | 36.5 |
| wt % | | | | |

TABLE 43
UHOS Runs Product Properties

| | Baseline | 13 | 14 | 15 |
|---|---|---|---|---|
| SCO Property | | | | |
| API Gravity | 12.9 | 13.7 | 19.2 | 16.7 |
| Viscosity @ 40° C., | 201 | 118 | 24.6 | 68.4 |
| cSt | | | | |
| Viscosity @ 100° C., | Nr | 20.7 | 4.59 | 7.27 |
| cSt | | | | |
| C7 Asphaltenes, wt % | Nr | 8.84 | 2.52 | 6.87 |
| Vanadium Content, | 88.0 | 197 | 72.2 | 170 |
| ppm | | | | |
| Nickel Content, ppm | 24.0 | 33.0 | 10.2 | 29.6 |
| Boiling Ranges | | | | |
| <200° F. Content, | 0.177 | 0 | 0 | 0 |
| wt % | | | | |
| 200-350° F. Content, | 1.92 | 4.52 | 6.41 | 5.16 |
| wt % | | | | |
| 350-500° F. Content, | 7.33 | 9.64 | 12.6 | 10.4 |
| wt % | | | | |
| 500-650° F. Content, | 8.25 | 15.4 | 20.7 | 17.4 |
| wt % | | | | |
| 650+° F. Content, | 82.3 | 70.4 | 60.3 | 67.0 |
| wt % | | | | |
| 650-850° F. Content, | 25.7 | 23.9 | 29.5 | 25.1 |
| wt % | | | | |
| 850-1000° F. Content, | 19.4 | 15.1 | 16.7 | 15.7 |
| wt % | | | | |
| 1000+° F. Content, | 37.2 | 31.4 | 14.1 | 26.2 |
| wt % | | | | |
| 1000-1200° F. Con- | 21.3 | 11.6 | 5.16 | 9.70 |
| tent, wt % | | | | |
| 1200+° F. Content, | 15.9 | 19.8 | 8.93 | 16.5 |
| wt % | | | | |

TABLE 44
UHOS Run Comparison

| | | | Liquid | Liquid | 1000+ | C7A | | V | Ni |
|---|---|---|---|---|---|---|---|---|---|
| | | | Yield, | Yield, | Removal, | Removal, | Viscosity | Removal, | Removal, |
| Configuration | Run ID | API | wt % | vol % | wt % | wt % | Reduction, % | wt % | wt % |
| Baseline | nr | 12.9 | 74.4 | nr | 49.9 | nr | 99.5 | 68.7 | 79.2 |
| 13 | U038A | 13.7 | 73.6 | 75.7 | 59.9 | 61.5 | 97.9 | 66.7 | 70.1 |
| 14 | U037B | 19.2 | 66.8 | 70.4 | 82.6 | 90.3 | 99.5 | 89.3 | 91.8 |
| 15 | U037A | 16.7 | 82.0 | 84.6 | 60.4 | 67.4 | 98.6 | 69.0 | 70.1 |

Table 45 compares the whole crude basis run properties of UHOS run configurations. Table 46 compares the product properties of the UHOS run configurations.

TABLE 45
UHOS Whole Crude Basis Run Properties Comparison

| Run Property | Baseline | 13 | 14 | 15 |
|---|---|---|---|---|
| Liquid Volume Yield, vol % | nr | 75.7 | 70.4 | 84.6 |
| Liquid Weight Yield, wt % | 74.4 | 73.6 | 66.8 | 82.0 |

TABLE 46
UHOS Run Product Properties Comparison

| SCO Property | Baseline | 13 | 14 | 15 |
|---|---|---|---|---|
| API Gravity | 12.9 | 13.7 | 19.2 | 16.7 |
| Viscosity Reduction, % | 99.5 | 97.9 | 99.5 | 98.6 |
| C7 Asphaltenes Removal, wt % | nr | 61.5 | 90.3 | 67.4 |
| Vanadium Removal, wt % | 68.7 | 66.7 | 89.3 | 69.0 |
| Nickel Removal, wt % | 79.2 | 70.1 | 91.8 | 70.9 |
| 1000° F.+ Material Removal, wt % | 49.9 | 59.9 | 82.6 | 60.4 |

Based on run properties of each configuration shown in Table 45, configuration 15 demonstrates greater success in liquid retention. Therefore, configuration 15 is more preferred.

Based on product properties of each configuration shown in Table 46, configuration 14 demonstrates superior product properties across the board, followed by configuration 15.

Combining the assessment of liquid yield and product properties, configuration 15 is vastly preferred due to the higher liquid volume yield. Therefore, configuration 15 (Nozzle 2000+Distributor 400 combination) is the most preferred configuration, for UHOS runs.

In the description above, for purposes of explanation only, specific nomenclature is set forth to provide a thorough understanding of the present disclosure. However, it will be apparent to one skilled in the art that these specific details are not required to practice the teachings of the present disclosure.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Improved reactor feed nozzles have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A feed nozzle, comprising:
an inner tubing encased within an outer heat shield tubing;
a first circular hole fabricated in the inner tubing, the first circular hole having a first diameter and serving as a discharge hole;
a second circular hole fabricated in the outer heat shield tubing, the second circular hole having a second diameter, wherein the second diameter is larger than the first diameter; and
a welded tip for extending a flow path at a declining angle, the welded tip having a section extending at a predetermined angle from the inner tubing to the discharge hole.

2. The feed nozzle of claim 1, wherein the feed nozzle is inserted perpendicularly into a tubular reactor.

3. The feed nozzle of claim 1, wherein the inner tubing is stainless steel.

4. The feed nozzle of claim 1, wherein the outer heat shield tubing is stainless steel.

5. The feed nozzle of claim 1, wherein the predetermined angle is 90°.

6. The feed nozzle of claim 1, wherein the predetermined angle is 45°.

7. The feed nozzle of claim 1, wherein the discharge hole is shaped according to an 8-sided star pattern.

8. The feed nozzle of claim 1, wherein the discharge hole is oval.

9. The feed nozzle of claim 1, wherein the section is vertical.

10. The feed nozzle of claim 1, wherein the section is diagonal.

11. The feed nozzle of claim 1, wherein the inner tubing has a liquid feed path and a gas feed path.
